(19) United States
(12) Patent Application Publication
(10) Pub. No.: US 2024/0267102 A1
(43) Pub. Date: Aug. 8, 2024

(54) METHOD AND APPARATUS FOR TRANSMISSION AND RECEPTION OF INFORMATION

(71) Applicant: Samsung Electronics Co., Ltd., Suwon-si (KR)

(72) Inventors: Zhe CHEN, Beijing (CN); Feifei SUN, Beijing (CN); Bin YU, Beijing (CN)

(21) Appl. No.: 18/431,784

(22) Filed: Feb. 2, 2024

(30) Foreign Application Priority Data
Feb. 2, 2023 (CN) 202310118208.2
May 8, 2023 (CN) 202310513025.0

(51) Int. Cl. H04B 7/06; H04W 8/22; H04W 24/02; H04W 80/02

(52) U.S. Cl. CPC H04B 7/0626; H04W 8/22; H04W 24/02; H04W 80/02

(57) ABSTRACT

The disclosure relates to a 5G or 6G communication system for supporting a higher data transmission rate. A method performed by a user equipment (UE) in a wireless communication system is provided. The method comprises receiving, from a base station, configuration information on a channel state information (CSI) report, wherein the configuration information includes information on one or more sub-configurations for the CSI report, receiving, from the base station, a medium access control (MAC) control element (CE) for activating at least one sub-configuration among the one or more sub-configurations and transmitting, to the base station, the CSI report for the at least one sub-configuration based on the MAC CE.

### CROSS-REFERENCE TO RELATED APPLICATIONS

This application is based on and claims priority under 35 U.S.C. § 119 to Chinese Patent Application No. 202310118208.2, filed on Feb. 2, 2023, and Chinese Patent Application No. 202310513025.0, filed on May 8, 2023, in the Chinese Intellectual Property Office, the disclosures of which are incorporated by reference herein in its entirety.

### BACKGROUND

### 1. Field

The present disclosure relates to a wireless communication system, and more specifically, to a method and an apparatus for transmission and reception of information.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

A method performed by a user equipment (UE) in a wireless communication system is provided. The method comprises receiving, from a base station, configuration information on a channel state information (CSI) report, wherein the configuration information includes information on one or more sub-configurations for the CSI report, receiving, from the base station, a medium access control (MAC) control element (CE) for activating at least one sub-configuration among the one or more sub-configurations and transmitting, to the base station, the CSI report for the at least one sub-configuration based on the MAC CE.

A user equipment (UE) in a wireless communication system is provided. The UE comprises a transceiver and a controller coupled with the transceiver and configured to receive, from a base station, configuration information on a channel state information (CSI) report, wherein the configuration information includes information on one or more sub-configurations for the CSI report, receive, from the base station, a medium access control (MAC) control element (CE) for activating at least one sub-configuration among the one or more sub-configurations, and transmit, to the base station, the CSI report for the at least one sub-configuration based on the MAC CE.

A method performed by a base station in a wireless communication system is provided. The method comprises transmitting, to a user equipment (UE), configuration information on a channel state information (CSI) report, wherein the configuration information includes information on one or more sub-configurations for the CSI report, transmitting, to the UE, a medium access control (MAC) control element (CE) for activating at least one sub-configuration among the one or more sub-configurations and receiving, from the UE, the CSI report for the at least one sub-configuration based on the MAC CE.

A base station in a wireless communication system is provided. The base station comprises a transceiver and a controller coupled with the transceiver and configured to transmit, to a user equipment (UE), configuration information on a channel state information (CSI) report, wherein the configuration information includes information on one or more sub-configurations for the CSI report, transmit, to the UE, a medium access control (MAC) control element (CE) for activating at least one sub-configuration among the one or more sub-configurations, and receive, from the UE, the CSI report for the at least one sub-configuration based on the MAC CE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of the present disclosure will be more apparent from the following detailed description when taken in conjunction with the accompanying drawings.

FIG. 1 illustrates an overall structure of an example wireless communication network according to various embodiments of the present disclosure;

FIG. 2A illustrates an example transmission path in a wireless communication network according to various embodiments of the present disclosure;

FIG. 2B illustrates a reception path in a wireless communication network according to various embodiments of the present disclosure;

FIG. 3A illustrates a structure of an example user equipment (UE) in a wireless communication network according to various embodiments of the present disclosure;

FIG. 3B illustrates a structure of an example gNodeB (gNB) in a wireless communication network according to various embodiments of the present disclosure;

FIG. 4A illustrates a flowchart of a method performed by a UE according to various embodiments of the present disclosure;

FIG. 4B illustrates a flowchart of a method performed by a UE according to various embodiments of the present disclosure;

FIG. 4C illustrates a flowchart of a method performed by a UE according to various embodiments of the present disclosure;

FIG. 4D illustrates a flowchart of a method performed by a UE according to various embodiments of the present disclosure;

FIG. 4E illustrates a flowchart of a method performed by a UE according to various embodiments of the present disclosure;

FIG. 4F illustrates a flowchart of a method performed by a UE according to various embodiments of the present disclosure;

FIG. 4G illustrates a flowchart of a method performed by a UE according to various embodiments of the present disclosure;

FIG. 4H illustrates a flowchart of a method performed by a UE according to various embodiments of the present disclosure;

FIG. 4I illustrates a flowchart of a method performed by a UE according to various embodiments of the present disclosure;

FIG. 4J illustrates a flowchart of a method performed by a UE according to various embodiments of the present disclosure;

FIG. 5A illustrates a flowchart of a method performed by a base station according to various embodiments of the present disclosure;

FIG. 5B illustrates a flowchart of a method performed by a base station according to various embodiments of the present disclosure;

FIG. 5C illustrates a flowchart of a method performed by a base station according to various embodiments of the present disclosure;

FIG. 5D illustrates a flowchart of a method performed by a base station according to various embodiments of the present disclosure;

FIG. 5E illustrates a flowchart of a method performed by a base station according to various embodiments of the present disclosure;

FIG. 6 illustrates a structure 600 of a UE according to various embodiments of the present disclosure; and

FIG. 7 illustrates a structure 700 of a base station according to various embodiments of the present disclosure.

### DETAILED DESCRIPTION

Hereinafter, embodiments of the present disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the present disclosure unclear will be omitted.

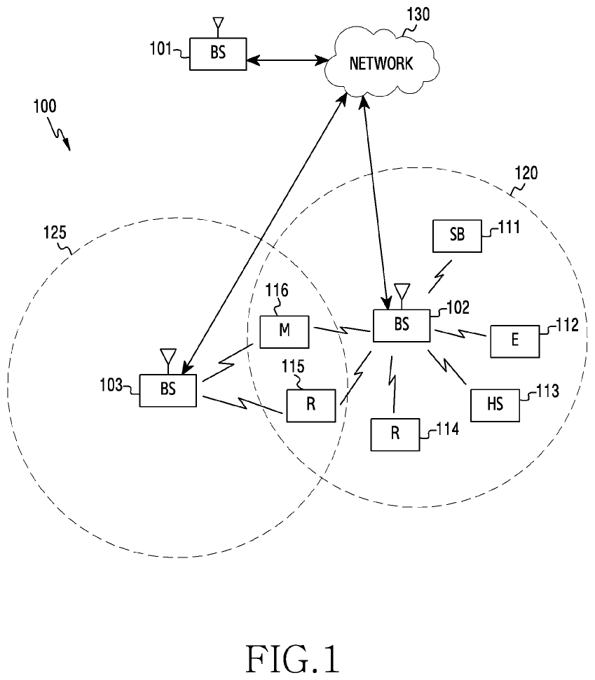

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

When describing the embodiments of the present disclosure, descriptions related to technical contents that are well known in the art and not directly related to the present disclosure will be omitted. Such omitting of unnecessary description is to prevent the main idea of the present disclosure from being blurred and to convey the main idea more clearly.

For the same reason, some elements may be exaggerated, omitted or schematically shown in the drawings. In addition, the size of each element does not fully reflect the actual size. In the drawings, the same or corresponding elements have the same reference numerals.

Advantages and features of the present disclosure and ways to achieve them will become clear by referring to the embodiments described in detail below in conjunction with the accompanying drawings. However, the present disclosure is not limited to the embodiments set forth below, but can be implemented in various forms. The following examples are provided only to fully disclose the present disclosure and to inform those skilled in the art of its scope, and the present disclosure is only limited by the scope of the appended claims. Throughout this specification, the same or similar reference numerals indicate the same or similar elements.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The transmission from a base station to a User Equipment (UE) is referred to as downlink, and the transmission from a UE to a base station is referred to as uplink.

The present disclosure provides a method and device for dynamically adjusting power parameters and/or spatial parameters of a UE, through which the UE can determine CSI parameters by acquiring first information related to power parameters and/or spatial parameters, thereby improving the CSI-related performance of the UE (for example, the accuracy of CSI feedback).

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

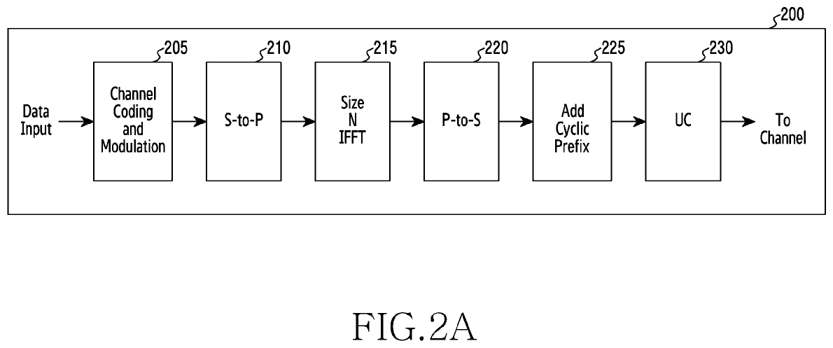

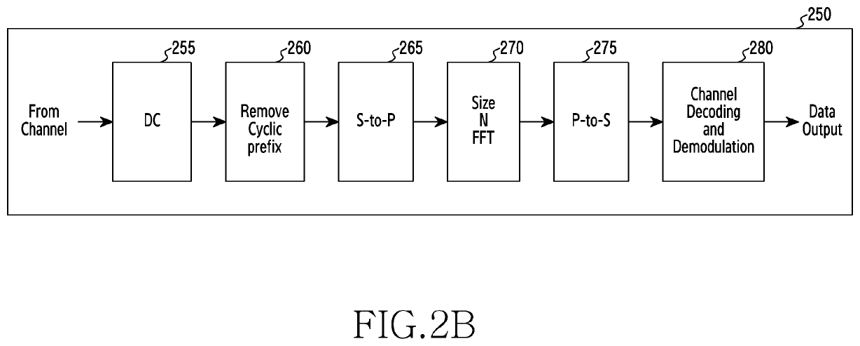

FIGS. 2A and 2B illustrate example wireless transmission and reception paths 200 and 250 according to various embodiments of the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

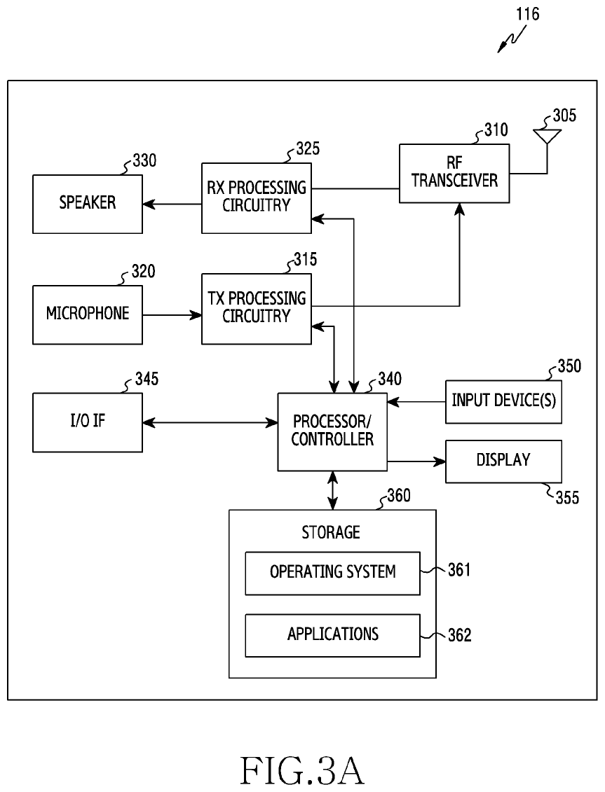

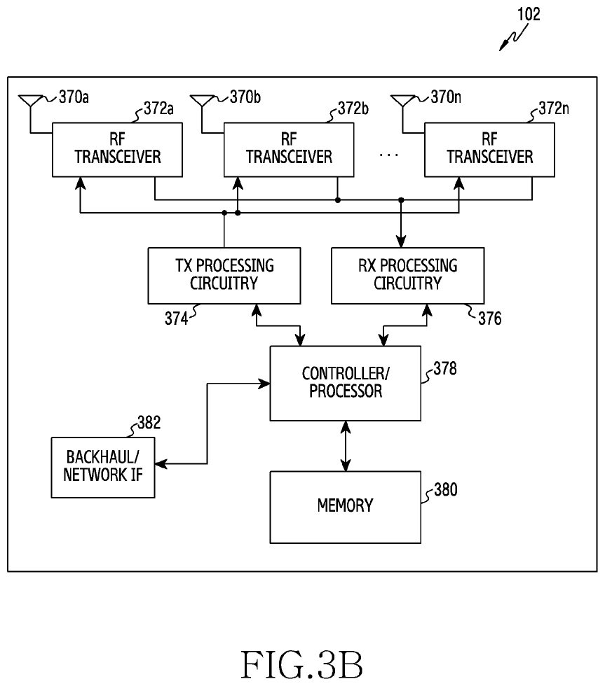

FIG. 3A illustrates an example UE 116 according to various embodiments of the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to various embodiment of the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and time division duplex (TDD) cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In order to enhance the scheduling flexibility of the 5G wireless communication system, an implementation is that a network device flexibly (for example, dynamically) changes the network device's power parameters and/or spatial parameters to adapt to the requirements of the user equipment at different times. However, at present, a UE may obtain the changes of power parameters and/or spatial parameters at the network device side in a semi-static way, which cannot meet the requirements of flexible adjustment at the base station side.

The present disclosure proposes a series of methods, through which the UE can determine CSI parameters by acquiring first information related to power parameters and/or spatial parameters, thereby improving the CSI-related performance of the UE (for example, the accuracy of CSI feedback).

Explanation is further made by various embodiments below.

### Embodiment 1

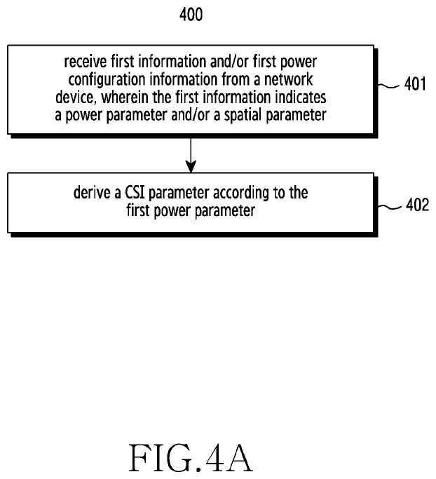

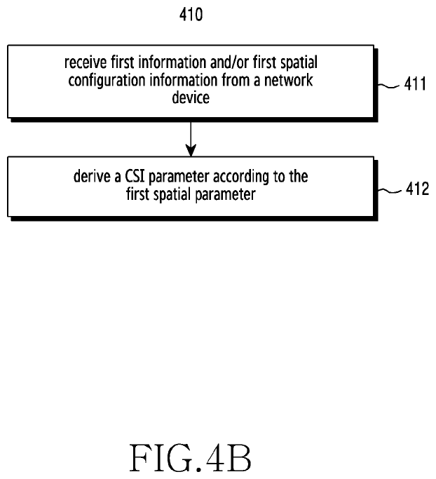

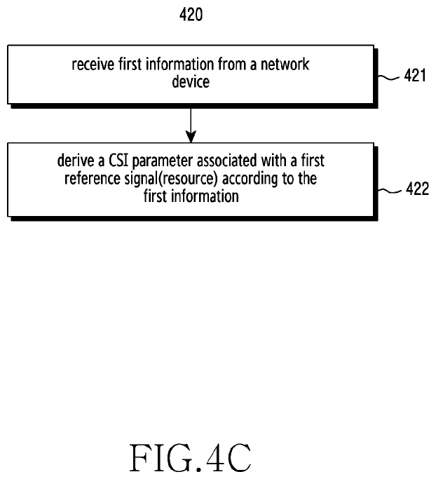

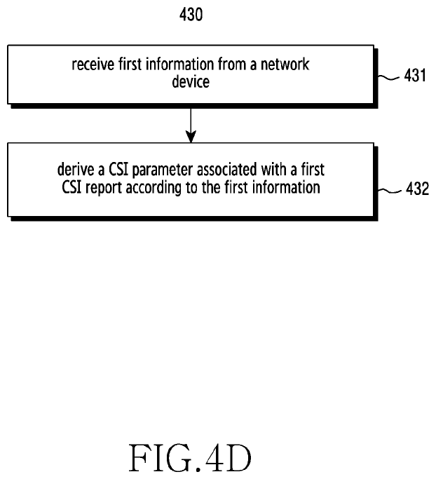

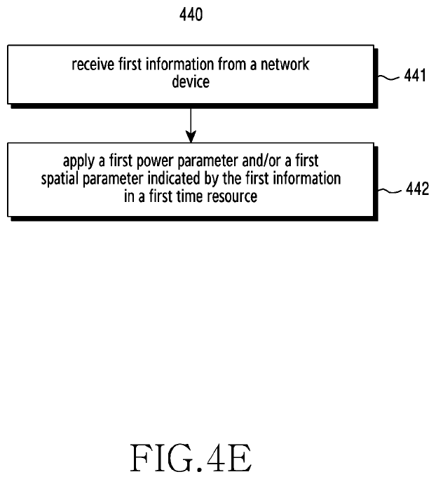

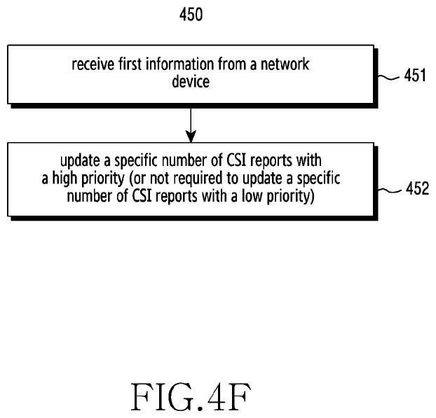

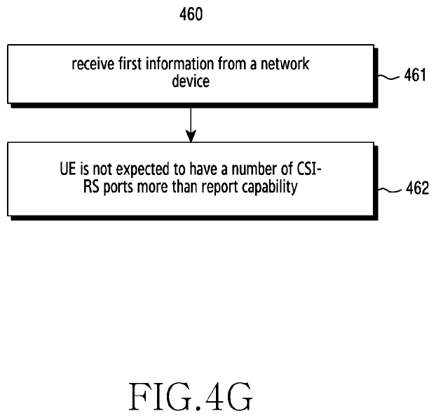

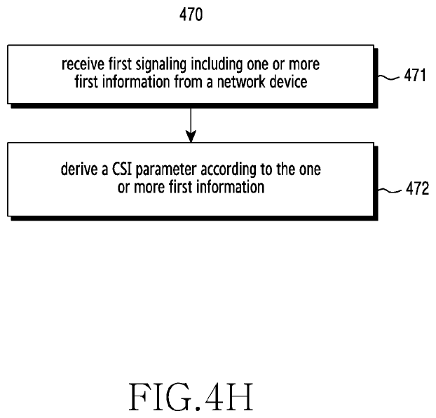

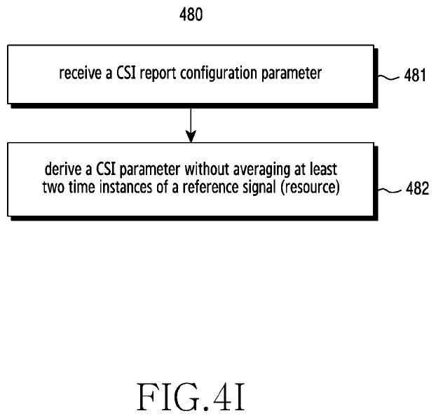

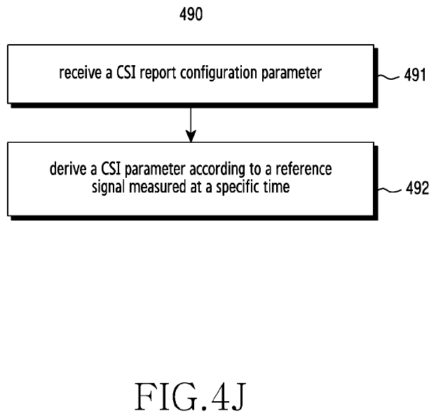

FIG. 4A illustrates a flowchart of a method 400 performed by a UE according to various embodiments of the present disclosure. The method 400 includes a step 401 and a step 402. At step 401, the UE receives first information and/or first power configuration information from a network device. At step 402, the UE assumes the first power parameter(s) for the purpose of deriving CSI parameter(s) and/or derives CSI parameter(s) according to the first power parameter(s); wherein the first power parameter(s) is determined by the first information and/or the first power configuration information.

The UE receives the first power configuration information.

For example, the first power configuration information is used to indicate (downlink) power parameters.

For example, the first power configuration information includes one or more power offset parameters (for example, power offset parameter(s) of physical downlink shared channel (PDSCH) resource element (RE) and non-zero power (NZP) channel state information reference signal resource element (CSI-RS RE), powerControlOffset). For example, the first power configuration information includes a list for power offset parameter(s).

For example, the first power configuration information is used for first reference signal (resource(s)) (of specific ID(s)).

The UE receives the first information (for indicating power parameters) from the network device. For example, the first information is used to adjust/update/indicate the power (parameter(s)). For example, the UE determines the first power parameter(s) according to the first information and/or the first power configuration information. For example, the first power parameter(s) is determined according to the first information and/or the first power configuration information. For example, a first power parameter represents a power relationship (power offset) between a PDSCH and a CSI-RS, for example, the ratio of PDSCH energy per RE (EPRE) to CSI-RS EPRE.

The UE determines the CSI parameter(s) according to the first power parameter(s). For example, the determining of the CSI parameter(s) may be determining of CSI feedback. The determining of the CSI parameter(s) may also be determining of a report that carries the CSI parameter(s) (that is, determining of a CSI report). For example, the CSI parameter(s) may include CSI feedback. The CSI parameter(s) may also be a report that carries the CSI parameter(s) (that is, a CSI report).

The determining of the CSI parameter(s) by the UE according to the first power parameter(s) means (can be understood as) that: if configured to report channel quality indicator (CQI) index, in the CSI reference resource, the UE assumes the first power parameter(s) for the purpose of deriving CSI parameter(s). The CSI parameter(s) include, for example, at least one of CQI index(es), precoding matrix indicator(s) (PMI) and rank indicator(s) (RI). For example, the CSI parameter(s) are the CQI index(es). For example, if the PMI(s) and RI(s) are configured, the CSI parameter(s) are the CQI index(es), PMI(s) and RI(s).

(When the UE receives the first information,) the first power parameter(s) is determined by at least one of the following methods:

### Method 1

The first power parameter(s) is determined according to the first information. For example, the first power parameter(s) is equal to (is) the power parameter(s) indicated/provided by the first information. For example, in case that a power parameter indicated by the first information is 6 dB, the first power parameter is 6 dB. For example, the UE ignores the power parameter(s) configured by the first power configuration information. For example, the power parameter(s) indicated by the first information overrides the power parameter(s) configured by the first power configuration information.

### Method 2

The first power parameter(s) is determined according to the first information and the first power configuration information. For example, the first power parameter(s) is determined by (a summation of) the power parameter(s) indicated by the first information and the power parameter(s) corresponding to (included in/configured by) the first power configuration information. For example, a downlink power configuration information configures a power parameter with a value of 6 dB, the power parameter indicated by the first information is −3 dB, and the first power parameter is 3 dB (that is, a summation of 6 dB and −3 dB).

### Method 3

The first power parameter(s) is determined according to the first information and the first power configuration information. For example, the first power configuration information corresponds to (includes/is configured with) one or more power parameters, and the first information indicates one or more of the one or more power parameters. For example, a downlink power configuration information is configured with three power parameters, which are 3 dB, 6 dB and 9 dB, respectively; the first information indicates the index of the parameters (or one of the parameters), for example, 3 dB, the first power parameter is 3 dB.

(When the UE does not receive the first information,) the first power parameter(s) is determined by at least one of the following methods:

### Method 1

(When the UE does not receive the first information,) the first power parameter(s) is equal to (refers to) the power parameter(s) corresponding to (included in/configured by) the first power configuration information. For example, (when the UE does not receive the first information from the network device,) in case that the power parameter(s) configured by the downlink power configuration information is 6 dB, the first power parameter(s) is 6 dB.

### Method 2

(When the UE does not receive the first information,) the first power parameter(s) is equal to (refers to) a predefined one of the power parameters corresponding to (included in/configured by) the first power configuration information. For example, the predefined one of the downlink power parameters refers to the first one/one with a smallest parameter ID in the first power configuration information. For example, (when the UE does not receive the first information from the network device,) the first power configuration information is configured with power parameters, which are 3 dB, 6 dB and 9 dB, respectively, the first power parameter is the first one in the first power configuration information (that is, 3 dB).

Embodiment 1 provides a method for determining power parameters, so that the UE can flexibly obtain power parameters (and then flexibly determine CSI parameters).

### Embodiment 2

FIG. 4B illustrates a flowchart of a method 410 performed by a UE according to various embodiments of the present disclosure. The method 410 includes a step 411 and a step 412. At step 411, the UE receives first information and/or first spatial configuration information from a network device. At step 412, the UE determines CSI parameter(s) according to first spatial parameter(s). The first spatial parameter(s) is determined by the first information and/or the first spatial configuration information.

The UE receives the first spatial configuration information.

For example, the first spatial configuration information includes one or more codebook configuration parameters (e.g., a parameter for configuring type 1 and type 2 codebooks, CodebookConfig). For example, the first spatial configuration information includes a codebook configuration parameter (e.g., a parameter for configuring type 1 and type 2 codebooks, CodebookConfig). For example, the first spatial configuration information includes one or more port (e.g., antenna port) parameters. For example, an antenna port parameter is used to indicate antenna ports (for example, indicating a number of antenna ports). For example, the antenna port parameter is used to indicate a number in the first dimension (N1) and a number in the second dimension (N2) of the antenna ports and/or the codebook subset restriction. For example, the codebook subset restriction is used for a single-panel codebook and/or a multi-panel codebook.

The UE receives the first information (for indicating spatial parameters) from the network device. For example, the first information is used to adjust/update the spatial domain (parameter(s)). For example, the UE determines the first spatial parameter(s) according to the first information and/or the first spatial configuration information. For example, the first spatial parameter(s) is determined according to the first information and/or the first spatial configuration information. For example, the first spatial parameter(s) represents (a number of) (antenna) ports and/or codebook restriction. For example, the first spatial parameter(s) represents at least one of a number of (antenna) ports, codebook subset and codebook restriction.

The UE determines the CSI parameter(s) according to the first spatial parameter(s). The determining of the CSI parameter(s) may be determining of CSI feedback. The determining of the CSI parameter(s) may also be determining of a report that carries the CSI parameter(s) (that is, determining of a CSI report). For example, the CSI parameter(s) may be CSI feedback. The CSI parameter(s) may also be a report that carries the CSI parameter (that is, a CSI report).

The determining of the CSI parameter(s) by the UE according to the first spatial parameter(s) means (can be understood as) that: in case that the UE is configured to report CQI index, in the CSI reference resource, the UE assumes the first spatial parameter(s) for the purpose of deriving CSI parameter(s). The CSI parameter(s) include, for example, at least one of CQI index(es), PMI(s) and RI(s). For example, the CSI parameter(s) are the CQI index(es). For example, in case that the PMI(s) and RI(s) are configured, the CSI parameter(s) are the CQI index(es), PMI(s) and RI(s).

(When the UE receives the first information,) the first spatial parameter(s) is determined by at least one of the following methods:

### Method 1

The first spatial parameter(s) is determined according to the first information. For example, the first spatial parameter(s) is equal to (is) the spatial parameter(s) indicated/provided by the first information. For example, in case that a spatial parameter indicated by the first information is codebook (configuration) #1, the first spatial parameter is also codebook (configuration) #1. For example, the UE ignores the spatial parameter(s) configured by the first spatial configuration information. For example, the spatial parameter(s) indicated by the first information overrides the spatial parameter(s) configured by the first spatial configuration information.

### Method 2

The first spatial parameter(s) is determined according to the first information and the first spatial configuration information. For example, the first spatial parameter(s) is determined by (the union or intersection of) the spatial parameter(s) indicated by the first information and the spatial parameter(s) corresponding to (included in/configured by) the first spatial configuration information. For example, a first spatial configuration information is configured with a codebook restriction, and the corresponding (unallowed) codebook subset is A and a first information indicates a codebook restriction, and the corresponding (unallowed) codebook subset is B, the codebook restriction corresponding to the first spatial parameter is the union or intersection of A and B. For another example, the first spatial configuration information is configured with an antenna port set A and the first information indicates an antenna port set B, the antenna port set corresponding to the first spatial parameter is the union or intersection of A and B. For another example, the first spatial configuration information is configured with a number of antenna ports A1 and the first information indicates a number of antenna ports B1, the number of antenna ports corresponding to the first spatial parameter is the largest/smallest number among A1 and B1.

### Method 3

The first spatial parameter(s) is determined according to the first information and the first spatial configuration information. For example, the first spatial configuration information corresponds to (includes/is configured with) one or more spatial parameters, and the first information indicates one or more of the one or more spatial parameters. For example, the first spatial configuration information is configured with three spatial parameters, which are codebook (configuration) #1, codebook (configuration) #2 and codebook (configuration) #3, respectively. The first information indicates the index of the parameters (or one of the parameters), such as codebook (configuration) #1, then the first spatial parameter is codebook (configuration) #1.

(When the UE does not receive the first information,) the first spatial parameter(s) is determined by at least one of the following methods:

### Method 1

(When the UE does not receive the first information,) the first spatial parameter(s) is equal to (refers to) the spatial parameter corresponding to the first spatial configuration information. For example, (when the UE does not receive the first information from the network device,) in case that the spatial parameter(s) configured by the first spatial configuration information is codebook (configuration) #1, the first spatial parameter(s) is codebook (configuration) #1.

### Method 2

(When the UE does not receive the first information,) the first spatial parameter(s) is equal to (refers to) the predefined one of the spatial parameters corresponding to the first spatial configuration information. For example, the predefined one of the spatial parameters refers to the first parameter or the parameter with the smallest ID in the first spatial configuration information. For example, (when the UE does not receive the first information from the network device,) the first spatial configuration information is configured with spatial parameters, which are codebook (configuration) #1, codebook (configuration) #2 and codebook (configuration) #3, respectively, then the first spatial parameter is the first one in the first spatial configuration information (that is, codebook (configuration) #1).

Embodiment 2 provides a method for determining spatial parameters, so that the UE can flexibly obtain spatial parameters (and then flexibly determine CSI parameters).

### Embodiment 3

FIG. 4C illustrates a flowchart of a method 420 performed by a UE according to various embodiments of the present disclosure. The method 420 includes a step 421 and a step 422. At step 421, the UE receives first information from a network device and at step 422 the UE determines CSI parameter(s) associated with first reference signal(s) (resource(s)) according to the first information. The first reference signal(s) satisfies at least one of the following conditions: the first reference signal(s) (resource(s)) is determined according to the first information; set(s) associated with the first reference signal(s) (resource(s)) is specific set(s); the first reference signal(s) (resource(s)) is associated with specific beam parameter(s); the first reference signal(s) (resource(s)) is associated with a specific Physical Cell ID (PCI); the first reference signal(s) (resource(s)) is associated with specific serving cell(s); the first reference signal(s) (resource(s)) is at least one of periodic, semi-persistent and aperiodic; and a number of ports of the first reference signal(s) (resource(s)) is greater than or equal to a specific number of ports. For example, when the first reference signal satisfies at least one of the above conditions, the UE determines the CSI parameter(s) associated with the first reference signal(s) (resource(s)) according to the first information.

The UE receives the first information (for indicating power parameter(s) and/or spatial parameter(s)) from the network device.

The UE determines the CSI parameter(s) associated with the first reference signal(s) (resource(s)) according to the first information (or according to the first power parameter(s) and/or the first spatial parameter(s) determined by the first information). The determining of the CSI parameter(s) may be determining of CSI feedback. The determining of the CSI parameter(s) may also be determining of a report that carries the CSI parameter(s) (that is, determining of a CSI report). For example, the CSI parameter(s) may be CSI feedback. The CSI parameter(s) may also be a report that carries the CSI parameter(s) (that is, a CSI report). For example, the method of determining the first power parameter(s) refers to Embodiment 1. For example, the method of determining the first spatial parameter(s) refers to Embodiment 2.

For example, reference signal resource set(s) in which the first reference signal (resource) is located is configured with a specific first parameter (e.g., trs-info) (for indicating that the antenna ports of all reference signal resources in the reference signal resource set are the same or used for tracking). For example, the reference signal resource set(s) in which the first reference signal(s) (resource(s)) is located is not configured with the first parameter(s) and/or is not configured with the second parameter(s) (e.g., repetition) for indicating whether repetition is on or off.

The determining of the CSI parameter(s) by the UE according to the first power parameter(s) and/or the first spatial parameter(s) means (can be understood as) that: in case that the UE is configured to report CQI index(es), in the CSI reference resource, the UE determines the CSI parameter(s) according to the first power parameter(s) and/or the first spatial parameter(s). The CSI parameter(s) includes, for example, at least one of CQI index(es), PMI(s) or RI(s). For example, the CSI parameter(s) includes the CQI index(es). For example, in case that the PMI(s) and RI(s) are configured, the CSI parameter(s) is the CQI index(es), PMI(s) and RI(s).

The following describes what conditions the first reference signal(s) satisfies, or how the UE determines the first reference signal(s) (and then determines the CSI parameter(s) associated with the first reference signal(s)) after receiving the first information, or these conditions can be used to determine which first reference signal(s) (resource(s)) are suitable for the first information. When these conditions are satisfied, the UE determines the CSI parameter(s) associated with the first reference signal(s) (according to the first information). For example, the UE determines the CSI parameter(s) associated with the first reference signal according to the first power parameter(s) and/or the first spatial parameter(s).

The first reference signal(s) (resource(s)) satisfies at least one of the following conditions/characteristics (in other words, the first reference signal(s) (resource(s)) refers to at least one of the following):
the first reference signal(s) (resource(s)) is determined according to the first information;
the set associated with the first reference signal resource is (or is associated with) a specific set;
the first reference signal(s) (resource(s)) is associated with specific spatial parameter(s);
the first reference signal(s) (resource(s)) is associated with specific Physical Cell ID(s) (PCI);
the first reference signal(s) (resource(s)) is associated with specific serving cell(s);
the first reference signal(s) (resource(s)) is associated with at least one of periodic, semi-persistent and aperiodic;
the number of ports of the first reference signal(s) (resource(s)) is greater than or equal to a specific number of ports;
the spatial parameter(s) associated with the first reference signal(s) (resource(s)) are determined according to the configured/indicated port information (for example, a number of ports); and
the port(s) associated with the first reference signal(s) (resource(s)) is determined according to at least one of the first spatial parameter(s), the second spatial parameter(s) and the port set associated with the first reference signal(s) (resource(s)).

### Example 1

Here, it is illustrated that the first reference signal(s) (resource(s)) is determined from the first information by at least one of the following methods. For example, the first reference signal resource(s) being determined according to the first information means that the first reference signal resource(s) is indicated by the first information.

### Method 1

The first information also indicates (or includes) cell information and/or reference signal resource information. The first reference signal resource(s) is determined according to the cell information and/or the reference signal resource information. For example, the first reference signal resource(s) refers to the reference signal resource(s) indicated by the reference signal resource information in the serving cell indicated by the cell information. For example, the cell information includes (refers to) a cell ID or a serving cell ID. For example, the reference signal resource information includes one or more CSI-RS resource ID(s) (NZP-(SI-RS-ResourceId). For example, the reference signal resource(s) is CSI-RS resource(s).

### Method 2

The first information indicates (or includes) cell information and/or reference signal resource set information. The first reference signal resource(s) is determined according to the cell information and/or the reference signal resource set information. For example, the first reference signal resource(s) refers to (all or part of) reference signal resource(s) included in/associated with the reference signal resource(s) indicated by the reference signal resource set information in the serving cell indicated by the cell information. For example, the cell information includes (refers to) cell ID(s) or a serving cell ID. For example, the reference signal resource set information includes one or more CSI-RS resource set ID(s) (NZP-(SI-RS-ResourceSetId). For example, the reference signal resource(s) is CSI-RS resource(s).

### Method 3

The first information indicates (or includes) cell information and/or CSI resource setting information. The first reference signal resource(s) is determined according to the cell information and/or CSI resource setting information. For example, the first reference signal resource(s) refers to (all or part of) reference signal resource(s) included in/associated with CSI resource setting indicated by CSI resource setting information in the serving cell indicated by cell information. For example, the cell information includes (refers to) a cell ID or a serving cell ID. For example, the CSI resource setting information includes one or more CSI resource setting ID(s) (CSI-ResourceConfigId). For example, the reference signal resource(s) is CSI-RS resource(s).

### Method 4

The first information indicates (or includes) cell information and/or CSI report setting information. The first reference signal resource is determined according to the cell information and/or CSI report setting information. For example, the first reference signal resource refers to (all or part of) reference signal resources (used for channel measurement) included in/associated with the CSI report setting indicated by the CSI report setting information in the serving cell indicated by the cell information. For example, the cell information includes (refers to) cell ID(s) or serving cell ID(s). For example, the CSI report setting information includes one or more CSI report setting ID(s) (CSI-ReportConfigId). For example, the reference signal resource(s) is CSI-RS resource(s).

### Method 5

The first information is carried by signaling/information (for example, downlink control information (DCI) format or a medium access control (MAC)-control element (CE), and for another example, the signaling described in Embodiment 8), and the signaling/information is also used to trigger one or more CSI report(s). The first reference signal resource(s) is determined according to the one or more CSI report(s). For example, the first reference signal resource(s) refers to (all or part of) reference signal resource(s) (used for channel measurement) included in or associated with the one or more CSI report(s) (setting(s)). For example, the reference signal resource(s) is CSI-RS resource(s).

For example, when the UE receives a signaling/information, which includes the first information and is also used to trigger one or more CSI report(s), the UE determines the CSI parameter(s) associated with the one or more CSI report(s) (corresponding/associated CSI-RS resources (for channel measurement) associated with the one or more CSI report(s)) according to the first power parameter(s) and/or the first spatial parameter(s) indicated by the first information.

For example, the one or more CSI report(s) refer to semi-persistent report(s) and/or aperiodic report(s).

### Example 2

Here, it is illustrated that the set(s) associated with the first reference signal(s) (resource(s)) is (or is associated with) a specific set (or that the first reference signal(s) (resource(s)) is associated with specific set(s)).

For example, the specific set(s) refers to predefined set(s) or preconfigured set(s). The predefined set(s) is, for example, a set with an ID of 0. The predefined set is, for example, a set with the lowest ID. The preconfigured set includes, for example, set configured(s) by radio resource control (RRC) signaling. For example, the specific set(s) refers to set(s) indicated by the first information. For example, the specific set is set(s) associated with signaling carrying the first information. For example, the set associated with the DCI format carrying the first information is received. For example, the control resource set pool index (for example, control resource set pool index #0) associated with the DCI format carrying the first information is received.

For example, a set is defined/determined by at least one of a loop ID, a control resource set (CORESET) pool index (CORESETPoolIndex), and a set ID.

“The set being defined by the loop ID” is used as an example to illustrate “the set associated with the first reference signal (resource) being the specific set”. “Loop ID” can be replaced with “CORESET pool index” or “set ID”. The first CSI-RS resource(s) is used as an example of the first reference signal resource(s).

The loop ID(s) associated with the first CSI-RS resource(s) is determined by at least one of the following methods:

### Method 1

The loop ID associated with the first CSI-RS resource(s) is predefined (for example, the associated loop ID is 0). For example, when the UE does not receive the configuration information (for indicating the loop ID(s) corresponding to the CSI-RS resource) from the network device, the loop ID(s) associated with the CSI-RS resource is predefined (for example, the associated loop ID is 0).

### Method 2

The set associated with the first CSI-RS resource(s) is indicated/configured by the base station. For example, the UE receives configuration information (for indicating the loop ID(s) corresponding to the CSI-RS resource(s)) from the network device. For example, the configuration information indicates one or more CSI-RS resource IDs (for example, NZP-CSI-RS-ResourceId) and one or more (one-to-one correspondence) loop ID(s). CSI-RS resources corresponding to the one or more CSI-RS resource ID(s) are (respectively) associated with the one or more loop IDs (or the CSI-RS resources belong to the set corresponding to the loop ID). For example, the configuration information indicates one or more CSI-RS resource set ID(s) (for example, NZP-(SI-RS-ResourceSetId) and one or more (one-to-one correspondence) loop ID(s). The CSI-RS resources in the CSI-RS resource set corresponding to the one or more CSI-RS resource set ID(s) are associated with the one or more (corresponding) loop IDs (or the CSI-RS resources belong to the set corresponding to the loop ID). For example, the configuration information indicates one or more CSI resource setting ID(s) (CSI-ResourceConfigId) and one or more (one-to-one correspondence) loop ID(s). CSI-RS resource(s) included in/associated with the CSI resource settings corresponding to the one or more CSI resource setting ID(s) are (respectively) associated with the one or more loop ID(s) (or, the CSI-RS resource(s) belong to the set corresponding to the loop ID(s)). For example, in case that the configuration information indicates one or more CSI report setting ID(s) (CSI-ReportConfigId) and one or more (one-to-one correspondence) loop ID(s), the CSI-RS resource(s) (used for channel measurement) included in the CSI report settings corresponding to the one or more CSI report setting ID(s) are (respectively) associated with the one or more loop IDs (or, the CSI-RS resources belong to the set corresponding to the loop ID(s)).

“The set associated with the first reference signal (resource) being the specific set” means that the loop ID corresponding to the first CSI-RS resource is a specific loop ID. For example, the specific loop ID is 0. For example, the specific loop ID is the lowest loop ID. For example, the specific loop ID(s) is the loop ID(s) indicated by the first information. That is, when the UE receives the first information and the loop ID(s) corresponding to the first CSI-RS resource(s) is the specific loop ID(s) (or is equal to the specific loop ID(s)), the UE determines the CSI parameter(s) associated with the first CSI-RS resource(s) (according to the corresponding first power parameter(s) and/or the corresponding first spatial parameter(s)).

For example, if the UE is configured with a CSI-ReportConfig with the higher layer parameter reportQuantity set to ‘cri-RI-PMI-CQI’, or ‘cri-RI-LI-PMI-CQI’ and the corresponding NZP-CSI-RS-ResourceSet for channel measurement is configured with Ks≥2 resources, two Resource Groups with K1≥1 resources in Group 1, K2≥1 resources in Group 2 and N Resource Pairs, then the group(s) associated with the first reference signal(s) (resource(s)) is Group1 (or Group2), or, the group(s) associated with the first reference signal(s) (resource(s)) is Group 1 and Group 2, or the first reference signal(s) (resource(s)) is not associated with Group 1 (or Group 2). For example, K1+K2=Ks.

For example, when the UE receives the first information, the UE determines the CSI parameter(s) associated with the first CSI-RS resource(s) in Group 1 (or Group 2) (according to the first power parameter(s) and/or the first spatial parameter(s)).

For example, when the UE receives the first information, the UE determines the CSI parameter associated with the first CSI-RS resources in Group 1 and Group 2 (according to the first power parameter and/or the first spatial parameter). That is, the first power parameter and/or the first spatial parameter are used/applied for both Group 1 and Group 2 (respectively).

For example, when the UE receives the first information, the UE does not apply the first power parameter(s) and/or the first spatial parameter(s) when determining the CSI parameter(s) based on a pair of reference signal resources (or reference signal resource(s) in Group 1 and Group 2).

### Example 3

Here, it is illustrated that the first reference signal(s) (resource(s)) is associated with the specific beam parameter(s).

For example, the beam parameter(s) is, for example, at least one of transmission configuration indication (TCI) state (ID), synchronization signal block (SSB) (ID) and CSI-RS (ID).

The first reference signal(s) (resource(s)) being associated with the specific beam parameter(s) means at least one of:
the first reference signal(s) (or the reference signal(s) corresponding to the first reference signal resource(s)) is quasi-colocated (QCL) with specific TCI state(s) (associated reference signal(s));
the first reference signal(s) (or the reference signal(s) corresponding to the first reference signal resource(s)) is quasi-colocated with specific SSB(s) (or SSB associated with SSB ID(s)); and
the first reference signal(s) (or the reference signal(s) corresponding to the first reference signal resource(s)) is quasi-colocated with a specific CSI-RS (or CSI-RS associated with CSI-RS ID).

For example, the specific beam parameter(s) refers to a predefined beam parameter(s) or beam parameter(s) determined by the first information (or beam parameter(s) indicated by the first information). For example, the predefined beam parameter(s) refers to the beam parameter with ID 0 or the beam parameter with the lowest ID. For example, the predefined beam parameter(s) is the TCI state/QCL assumption of CORESET 0 (in the active BWP) (or the CORESET with the smallest ID).

For example, when the UE receives the first information and the first reference signal (s) (resource(s)) is associated with specific beam parameter(s) (or the beam parameter(s) associated with the first reference signal(s) (resource(s)) is the same as the specific beam parameter(s)), the UE determines the associated CSI parameter(s) of the first reference signal resource(s) (according to the first power parameter(s) and/or the first spatial parameter(s)).

### Example 4

Here, it is illustrated that the first reference signal(s) (resource(s)) is associated with specific physical cell ID(s).

For example, the first reference signal(s) (resource(s)) being associated with the specific physical cell ID(s) means that the source reference signal(s) of the first reference signal(s) (resource(s)) is associated with the specific physical cell ID(s). For example, the specific physical cell ID(s) being associated with the first reference signal(s) (resource(s)) means that the reference signal(s) (for example, SSB(s)) quasi-colocated with the first reference signal(s) (resource(s)) is associated with the specific physical cell ID(s).

For example, the specific physical cell ID(s) refers to (or includes/is associated with) physical cell ID(s) different from the serving cell(s). For example, the specific physical cell ID(s) refers to the same physical cell ID as the serving cell(s). For example, the specific physical cell ID(s) refers to the physical cell ID(s) indicated by the first information.

For example, when the UE receives the first information and the first reference signal (s) (resource(s)) is associated with specific physical cell ID(s) (or the physical cell ID(s) associated with the first reference signal(s) (resource(s)) is equal to/the same as the specific physical cell ID(s)), the UE determines the associated CSI parameter(s) of the first reference signal resource(s) (according to the first power parameter(s) and/or the first spatial parameter(s)).

### Example 5

Here, it is illustrated that the first reference signal (resource) is associated with specific serving cell(s).

For example, the first reference signal(s) (resource(s)) being associated with the specific serving cell(s) means that the first reference signal(s) (resource(s)) belongs to the specific serving cell(s).

For example, the specific serving cell(s) refers to primary cell (PCell). For example, the specific serving cell(s) refers to a secondary cell (SCell). For example, the specific serving cell(s) refers to active serving cell(s). For example, the specific serving cell(s) refers to one or more preconfigured or predefined (serving) cell(s) (for example, cell(s) provided by a cell list). For example, the specific serving cell(s) refers to serving cell(s) indicated by the first information.

For example, when the UE receives the first information and the first reference signal (s) (resource(s)) is associated with specific serving cell(s) (or the serving cell(s) associated with the first reference signal(s) (resource(s)) is the same as the specific serving cell(s)), the UE determines the associated CSI parameter(s) of the first reference signal resource(s) (according to the first power parameter(s) and/or the first spatial parameter(s)).

### Example 6

Here, the first reference signal(s) (resource(s)) is at least one of periodic, semi-persistent and aperiodic.

For example, the first reference signal(s) (resource(s)) being periodic means that the first reference signal(s) (resource(s)) (corresponding reference signal set(s)) is periodic. For example, the time domain behavior of resource configuration of the reference signal set is periodic (for example, the resource Type parameter is set to “periodic”). The first reference signal resource is, for example, CSI-RS resource. The reference signal set is, for example, CSI-RS resource set.

For example, the first reference signal(s) (resource(s)) being semi-persistent means that the first reference signal(s) (resource(s)) (corresponding reference signal set(s)) is semi-persistent. For example, the time domain behavior of resource configuration of the reference signal set(s) is semi-persistent (for example, the resourceType parameter is set to “semi-persistent”). The first reference signal resource(s) is, for example, CSI-RS resource(s). The reference signal set(s) is, for example, CSI-RS resource set(s).

For example, the first reference signal(s) (resource(s)) being aperiodic means that the first reference signal(s) (resource(s)) (corresponding reference signal set(s)) is aperiodic. For example, the time domain behavior of resource configuration of the reference signal set(s) is aperiodic (for example, the resource Type parameter is set to “aperiodic”). The first reference signal resource(s) is, for example, CSI-RS resource(s). The reference signal set(s) is, for example, CSI-RS resource set(s).

For example, when the UE receives the first information and the first reference signal (s) (resource(s)) is periodic and/or semi-persistent, the UE determines the associated CSI parameter(s) of the first reference signal resource(s) (according to the first power parameter(s) and/or the first spatial parameter(s)).

For example, when the UE receives the first information and the first reference signal(s) (resource(s)) is semi-persistent and/or aperiodic, the UE determines the associated CSI parameter(s) of the first reference signal resource(s) (according to the first power parameter(s) and/or the first spatial parameter(s)).

### Example 7

Here, it is illustrated that a number of ports of the first reference signal (resource) is greater than or equal to a specific number of ports.

For example, the number of ports of the first reference signal(s) (resource(s)) refers to the number of CSI-RS ports. For example, the number of CSI-RS ports of the first reference signal(s) (resource(s)) is provided by parameters in the configuration information of the first reference signal resource (for example, nrofPorts in resourceMapping).

For example, the specific number of ports is a predefined number. For example, at least one of 32, 24, 16, 8, 4 and 2. For example, the specific number of ports is the number of ports indicated by the first information. For example, the specific number of ports is the number of ports determined according to the first information (for example, the number of ports associated with/corresponding to the spatial parameters indicated by the first information). For example, if the spatial parameters provide the number of ports N1 in the first dimension and the number of ports N2 in the second dimension, the specific number of ports is equal to 2*N1*N2. For example, the ports may be antenna ports. For example, the ports may be CSI-RS ports. For example, if the spatial parameters provide the number of ports N1 in the first dimension and the number of ports N2 in the second dimension and/or the parameter Ng, and is associated with/corresponding to a multi-panel codebook (for example, the codebook parameter is set to type 1 multi-panel, and for example, the parameter codebookType is set to “typeI-MultiPanel”), the specific number of ports is equal to 2*Ng*N1*N2. Here, the parameter Ng is used to indicate the number of panels, for example. For example, if the spatial parameters provide the number of ports N1 in the first dimension and the number of ports N2 in the second dimension, and is associated with/corresponding to a single-panel codebook (for example, the codebook parameter is set to type 1 single-panel, and for example, the parameter codebookType is set to “typeISinglePanel”), the specific number of ports is equal to 2*N1*N2.

For example, when the UE receives the first information and a number of ports of the first reference signal (resource) is less than or equal to a specific number of ports (determined according to the first information), the UE determines the CSI parameter(s) of the first reference signal resource (association) (according to the first spatial configuration information).

For example, when the UE receives the first information and the number of ports of the first reference signal (resource) is greater than or equal to a specific number of ports (determined according to the first information), the UE determines the (associated) CSI parameter(s) of the first reference signal resource(s) (according to the first spatial parameters determined by the first information).

For example, when the number of ports of the first reference signal resource is different from the specific number of ports (or when the number of ports of the first reference signal resource is less than (or equal to) the specific number of ports), the UE drops or does not generate CSI parameter(s) (or CSI report(s)). The CSI-RS resource(s) is used as an example of the first reference signal resource(s), and the codebook configuration parameter determined by the first information is used as an example of the specific number of ports. When the number of ports (for example, 32) of (corresponding to) the codebook configuration parameter is greater than the number of CSI-RS ports (for example, 16), the UE drops or does not generate CSI parameters (associated with/corresponding to the CSI-RS resource). If the UE determines CSI parameter(s) based on a pair of CSI-RS resources, and at least one CSI-RS resource of the pair of CSI-RS resources satisfies the above conditions (for example, less than or equal to a specific number of ports), the UE drops or does not generate CSI parameter(s) (or CSI report(s)).

When the number of ports of the first reference signal resource(s) is the same as the specific number of ports, the UE determines CSI parameter(s) according to (all of) ports of the first reference signal resource(s).

When the number of ports of the first reference signal resource(s) is different from the specific number of ports (or when the number of ports of the first reference signal resource is greater than or equal to the specific number of ports), the UE determines CSI parameters according to the subset of ports of the first reference signal resource(s).

Various methods of determining the ports of the first reference signal resource(s) are described below. Specifically, the various methods of determining the ports of the first reference signal resource are described below by using a subset of the ports of the first reference signal resource as an example. The first spatial parameter(s) (determined by the first information) is used as an example of the specific number of ports.

### Method 1

The (number of ports of) port subset of the first reference signal resource is determined according to a number of ports of the first spatial parameter(s). For example, the subset of ports of the first reference signal resource is determined according to a predefined rule. For example, the subset of the ports of the first reference signal resource is the subset with the smallest ID among the ports of the first reference signal resource. For example, when the number of ports of the first spatial parameter (e.g., codebook configuration parameter) is 16 and the number of ports (CSI-RS ports) of the first reference signal resource is 32, the number of the CSI-RS port subset is 16. For example, the port subset is the 16 ports with the smallest ID among the ports of the first reference signal resource.

The CSI-RS resource is used as an example of the first reference signal resource, the number of ports of the CSI-RS resource is configured as 32, and the code division multiplexing (CDM) type is “cdm8-FD2-TD4”. When the specific number of ports (or the number of ports of the first spatial parameter) is 8, the UE determines the CSI parameters according to the 8 ports with the smallest ID among the ports of the CSI-RS resource.

### Method 2

The (number of ports of) port subset of the first reference signal resource is determined according to a number of ports of the first spatial parameter(s). For example, the number of ports of the predefined reference signal is the same as that of the first spatial parameter. For example, the subset of ports of the first reference signal resource is determined according to the ports that (completely) overlap with the time-frequency resources of (ports of) the predefined reference signal. For example, the ports (completely) overlapping time-frequency resources correspond to the same CDM type. For example, for determining CSI parameters, the UE determines (assumes) that the port with the smallest index in the port subset is port (3000+) 0, and the port with the second smallest index is port (3000+) 1, and so on.

The CSI-RS resource is used as an example of the first reference signal resource, the number of ports of the CSI-RS resource is configured as 32, and the CDM type is “fd-CDM2”. The number of ports in the first spatial parameter is 8. The number of ports of the predefined CSI-RS is 8 and the CDM type is “fd-CDM2”. The UE determines CSI parameters according to 8 specific ports (overlapping with predefined CSI-RS time-frequency resources) among the ports of the CSI-RS resource. These specific numbers of ports are 3000, 3001, 3002, 3003 and 3008, 3009, 3010, 3011. For example, when determining the CSI parameters, the UE determines (assumes) that 3000 is 3000; 3001 is 3001; 3002 is 3002; 3003 is 3003; 3008 is 3004; 3009 is 3005; 3010 is 3006; 3011 is 3007.

For example, the parameters related to the predefined reference signal (e.g., the position of CSI-RS in a slot (e.g., time-frequency position)) can be determined according to Table 1 below. Table 1 below includes at least one of the following information: Row, Ports, density, code division multiplexing type (cdm-Type), CDM set index, parameter k̅, parameter l̅, parameter k′, parameter l′. For example, each row in the table represents a set of predefined parameters related to the reference signal. The terminal device can (implicitly) determine the subset of the ports of the first reference signal resource through the (indicated) spatial parameters according to predefined rules, thus reducing the signaling overhead indicated by the subset of ports.

TABLE 1

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | cdm4-FD2- | (k₀, l₀), (k₁, l₀) | 0, 1 | 0, 1 | 0, 1 |
| | | | TD2 | | | | |
| 9 | 12 | 1 | fd-CDM2 | (k₀, l₀), (k₁, l₀), (k₂, l₀), (k₃, l₀), (k₄, l₀), | 0, 1, 2, 3, 4, 5 | 0, 1 | 0 |
| | | | | (k₅, l₀) | | | |
| 10 | 12 | 1 | cdm4-FD2- | (k₀, l₀), (k₁, l₀), (k₂, l₀) | 0, 1, 2 | 0, 1 | 0, 1 |
| | | | TD2 | | | | |
| 11 | 16 | 1, 0.5 | fd-CDM2 | (k₀, l₀), (k₁, l₀), (k₂, l₀), (k₃, l₀), (k₀, l₀ + 1), | 0, 1, 2, 3, 4, 5, | 0, 1 | 0 |
| | | | | (k₁, l₀ + 1), (k₂, l₀ + 1), (k₃, l₀ + 1) | 6, 7 | | |
| 12 | 16 | 1, 0.5 | cdm4-FD2- | (k₀, l₀), (k₁, l₀), (k₂, l₀), (k₃, l₀) | 0, 1, 2, 3 | 0, 1 | 0, 1 |
| | | | TD2 | | | | |
| 13 | 24 | 1, 0.5 | fd-CDM2 | (k₀, l₀), (k₁, l₀), (k₂, l₀), (k₀, l₀ + 1), (k₁, l₀ + 1), | 0, 1, 2, 3, 4, 5, | 0, 1 | 0 |
| | | | | (k₂, l₀ + 1), (k₀, l₁), (k₁, l₁), (k₂, l₁), | 6, 7, 8, 9, 10, 11 | | |
| | | | | (k₀, l₁ + 1), (k₁, l₁ + 1), (k₂, l₁ + 1) | | | |
| 14 | 24 | 1, 0.5 | cdm4-FD2- | (k₀, l₀), (k₁, l₀), (k₂, l₀), (k₀, l₁), (k₁, l₁), | 0, 1, 2, 3, 4, 5 | 0, 1 | 0, 1 |
| | | | TD2 | (k₂, l₁) | | | |
| 15 | 24 | 1, 0.5 | cdm8-FD2- | (k₀, l₀), (k₁, l₀), (k₂, l₀) | 0, 1, 2 | 0, 1 | 0, 1, 2, 3 |
| | | | TD4 | | | | |
| 16 | 32 | 1, 0.5 | fd-CDM2 | (k₀, l₀), (k₁, l₀), (k₂, l₀), (k₃, l₀), (k₀, l₀ + 1), | 0, 1, 2, 3, 4, 5, | | 0 |
| | | | | (k₁, l₀ + 1), (k₂, l₀ + 1), (k₃, l₀ + 1), (k₀, l₁), | 6, 7, 8, 9, 10, 11, | | |
| | | | | (k₁, l₁), (k₂, l₁), (k₃, l₁), (k₀, l₁ + 1), (k₁, l₁ + 1), | 12, 13, 14, 15 | | |
| | | | | (k₂, l₁ + 1), (k₃, l₁ + 1) | | | |
| 17 | 32 | 1, 0.5 | cdm4-FD2- | (k₀, l₀), (k₁, l₀), (k₂, l₀), (k₃, l₀), (k₀, l₁), | 0, 1, 2, 3, 4, 5, | 0, 1 | 0, 1 |
| | | | TD2 | (k₁, l₁), (k₂, l₁), (k₃, l₁) | 6, 7 | | |
| 18 | 32 | 1, 0.5 | cdm8-FD2- | (k₀, l₀), (k₁, l₀), (k₂, l₀), (k₃, l₀) | 0, 1, 2, 3 | 0, 1 | 0, 1, 2, 3 |
| | | | TD4 | | | | |

### Method 3

The (number of ports of) port subset of the first reference signal resource is determined according to a number of ports of the first spatial parameter(s). For example, the subset of ports of the first reference signal resource is determined according to the ports that (completely) overlap with the time-frequency resources of (ports of) the predefined reference signal. For example, the number of ports of the predefined reference signal is 1. For example, the CDM type of the predefined reference signal is “no CDM”. For example, the frequency domain density of the predefined reference signal is 0.5 or 1 (per RB). For example, the frequency domain density of the predefined reference signal is the same as that of the first reference signal resource.

### Method 4

A subset of the ports of the first reference signal resource is configured by the base station. For example, the UE is (explicitly) configured by base station a subset of ports of the first reference signal resource(s). For example, the UE is (explicitly) configured by base station the port ID of the first reference signal resource for determining CSI parameters.

The CSI-RS resource is used as an example of the first reference signal resource, the number of ports of the CSI-RS resource is configured as 32. The base station (explicitly) configures ports of CSI-RS resources for determining CSI parameters as 0 (+3000), 4 (+3000), 7 (+3000) and 8 (+3000). The UE determines the CSI parameters according to the ports (3000, 3004, 3007, 3008) of the CSI-RS resource (corresponding time-frequency resource and/or the (orthogonal) cover code used by the time-frequency resource). For example, for determining the CSI parameters, the UE determines (assumes) that 3000 is 3000; 3004 is 3001; 3007 is 3002; 3008 is 3003.

### Example 8

Here, it is illustrated that the spatial parameters associated with the first reference signal (resource) are determined according to the configured/indicated port information. For example, the first spatial parameter associated with the first reference signal (resource) is determined according to the configured/indicated port information and the second spatial parameter.

For example, the condition that the method in Example 8 may need to be satisfied is that the codebook type associated with the first reference signal (resource) is a single-panel codebook. For example, this condition means that the codebook type parameter (codebookType) (based on RRC signaling) is set to “typeISinglePanel”.

For example, when the first spatial parameter associated with the first reference signal (resource) is not provided/configured/indicated, the first spatial parameter associated with the first reference signal (resource) is determined according to the configured/indicated port information and the second spatial parameter. When the first spatial parameter associated with the first reference signal (resource) is provided/configured/indicated, the first spatial parameter associated with the first reference signal (resource) is indicated (directly/explicitly) by the base station. For example, when the first spatial parameter associated with the first reference signal (resource) is provided/configured/indicated, and the port information is also provided/configured/indicated, the number of ports associated with the first spatial parameter is related/equal to the number of ports corresponding to the port information. For example, when the first spatial parameter includes the number of ports N1_subset in the first dimension and the number of ports N2_subset in the second dimension, and the port information includes the port number information or the port ID, N_port=2*N1_subset*N2_subset. Here, N_port refers to the number of ports corresponding to the port information. For example, when the port information refers to a set of port IDs, N_port is the number of this set of port IDs. For example, when the port information includes port number information, N_port is the number corresponding to the port number information.

For example, the UE determines the CSI parameters of (associated with) the first reference signal resource according to the first spatial parameters associated with the first reference signal (resource).

For example, the UE receives indication information/configuration information (from the base station). For example, the UE receives information (from the base station) indicated/configured by the first information (for example, port information). For example, the UE receives information (from the base station) associated with the first information (for example, port information). For example, the port information may be or may include port ID information. For example, the port information may be or may include port number information. For example, the port information may be or may include information of a used port. For example, the port information may be or may include information of unused/muted ports. For example, the port information may be or may include code division multiplexing (CDM) set information. One CDM group corresponds to/associates with one or more ports. For example, the port information may be or may include used CDM group information. For example, the port information may be or may include unused/muted CDM group information.

For example, the second spatial parameter may be or may include the number of ports N1 in the first dimension and the number of ports N2 in the second dimension.

For example, the first spatial parameter may be or may include the number of ports N1_subset in the first dimension and the number of ports N2_subset in the second dimension.

For example, the product of the number of ports (N1_subset) in the first dimension included in/associated with the first spatial parameter and the number of ports (N2_subset) in the second dimension included in/associated with the first spatial parameter is less than or equal to the product of the number of ports (N1) in the first dimension included in/associated with the second spatial parameter and the number of ports (N2) in the second dimension included in/associated with the second spatial parameter.

For example, the product of the number of ports (N1_subset) in the first dimension included in/associated with the first spatial parameter and the number of ports (N2_subset) in the second dimension included in/associated with the first spatial parameter has an integer multiple relationship (e.g., a multiple relationship with a power of 2) with the product of the number of ports (N1) in the first dimension included in/associated with the second spatial parameter.

For example, the number of ports (N1_subset) in the first dimension included in/associated with the first spatial parameter is less than or equal to the number of ports (N1) in the first dimension included in/associated with the second spatial parameter.

For example, the number of ports (N2_subset) in the second dimension included in/associated with the first spatial parameter is less than or equal to the number of ports (N2) in the second dimension included in/associated with the second spatial parameter.

For example, the number of ports (N1_subset) in the first dimension included in/associated with the first spatial parameter has an integer multiple relationship (for example, a multiple relationship with a power of 2) with the number of ports (N1) in the first dimension included in/associated with the second spatial parameter.

For example, the number of ports (N2_subset) in the second dimension included in/associated with the first spatial parameter has an integer multiple relationship (for example, a multiple relationship with a power of 2) with the number of ports (N2) in the second dimension included in/associated with the second spatial parameter.

The following describes how N1_subset and/or N2_subset is determined by the port ID information, N1 and N2, by using the port information as port ID information, the first spatial parameter as number of ports N1_subset in the first dimension and number of ports N2_subset in the second dimension.

For example, N1_subset is determined based on the (total) number of port IDs (port IDs corresponding to the information) in 0 (+3000) to N1-1 (+3000) (normalized port ID) corresponding to/associated with the port ID information. For example, the normalized port ID means that the value of the smallest (or largest) port ID in this set of port IDs (generated port ID) is subtracted from a set of port IDs corresponding to/associated with the port ID information. For example, N2_subset is determined based on N1_subset. For example, N2_subset=N_port/(2*N1_subset). N_port can be the number of port IDs (for example, the (total) number of ports corresponding to the port ID information). For example, N1_subset is equal to the (total) number of port IDs in 0 (+3000) to N1-1 (+3000) (normalized port ID) corresponding to/associated with the port ID information. For example, the port ID is 3000, 3001, 3004, 3005; N1=2; N2=2. Since the number of ports is 2 in the range of 3000 to 3001 (that is, 3000+N1-1), N1_subset=2. For example, the port ID is 3000, 3001, 3004, 3005; N1=2; N2=2. Since the normalized numbers of ports (0, 1,4,5) is in the range of 0 to 1 (i.e., N1-1) and the number of ports is 2, N1_subset=2.

For example, N1_subset is determined based on the corresponding/associated (maximum) consecutive port ID number of the port ID information. For example, N1_subset is determined based on the number of (maximum) consecutive port IDs corresponding/associated with the port ID information and N1. For example, N1_subset=N_con, where N_con represents the (maximum) number of consecutive port IDs corresponding to/associated with the port ID information. For example, N1_subset=min(N_con, N1), where N_con represents the (maximum) number of consecutive port IDs corresponding to/associated with the port ID information. For example, when the port ID is 3000, 3001, 3004, 3005, 3006, the maximum number of consecutive port IDs is 3.

For example, N2_subset is determined based on the (total) number of port IDs (port IDs corresponding to the information) in 0 (+3000) to N2-1 (+3000) (normalized port ID) corresponding to/associated with the port ID information. For example, the normalized port ID means that the value of the smallest (or largest) port ID in this set of port IDs (generated port ID) is subtracted from a set of port IDs corresponding to/associated with the port ID information. For example, N1_subset is determined based on N2_subset. For example, N1_subset=N_port/(2*N2_subset). N_port can be the number of port IDs (for example, the (total) number of ports corresponding to the port ID information). For example, N2_subset is equal to the (total) number of port IDs in the range of 0 (+3000) to N2-1 (+3000) (normalized port ID) corresponding to/associated with the port ID information. For example, the port ID is 3000, 3001, 3004, 3005; N1=2; N2=2. Since the number of ports is 2 in the range of 3000 to 3001 (that is, 3000+N2-1), N2_subset=2. For example, the port ID is 3000, 3001, 3004, 3005; N1=2; N2=2. Since the normalized numbers of ports (0,1,4,5) is in the range of 0 to 1 (i.e., N2-1) and the number of ports is 2, N1_subset=2.

For example, N2_subset is determined based on the corresponding/associated (maximum) consecutive port ID number of the port ID information. For example, N2_subset is determined based on the corresponding/associated (maximum) number of consecutive port IDs of the port ID information and N1. For example, N2_subset=N_con, where N_con represents the (maximum) number of consecutive port IDs corresponding to/associated with the port ID information. For example, N2_subset=min(N_con, N2), where N_con represents the (maximum) number of consecutive port IDs corresponding to/associated with the port ID information. For example, when the port ID is 3000, 3001, 3004, 3005, 3006, the maximum number of consecutive port IDs is 3.

In this example, the spatial parameters associated with the first reference signal (resource) can be (implicitly) determined according to the port indication information, thus reducing the signaling overhead generated by the indication of the related spatial parameters.

### Example 9

Here, it is illustrated that the spatial parameters associated with the first reference signal (resource) are determined according to the configured/indicated port information. For example, the first spatial parameter associated with the first reference signal (resource) is determined according to the configured/indicated port information and the second spatial parameter.

For example, the condition that the method in Example 9 may need to be satisfied is that the codebook type associated with the first reference signal (resource) is a multi-panel codebook. In other words, the condition means that the codebook type parameter (codebookType) (based on RRC signaling) is set to “typeI-MultiPanel”.

For example, when the first spatial parameter associated with the first reference signal (resource) is not provided/configured/indicated, the first spatial parameter associated with the first reference signal (resource) is determined according to the configured/indicated port information and the second spatial parameter. When the first spatial parameter associated with the first reference signal (resource) is provided/configured/indicated, the first spatial parameter associated with the first reference signal (resource) is indicated (directly/explicitly) by the base station. For example, when the first spatial parameter associated with the first reference signal (resource) is provided/configured/indicated, and the port information is also provided/configured/indicated, the number of ports associated with the first spatial parameter is related/equal to the number of ports corresponding to the port information. For example, when the first spatial parameter includes the number of ports N1_subset in the first dimension and the number of ports N2_subset in the second dimension and/or the parameter Ng_subset, and the port information includes port information or port number information or port ID, N_port=2*N1_subset*N2_subset*Ng_subset. Here, N_port refers to the number of ports corresponding to the port information. For example, when the port information refers to a set of port IDs, N_port is the number of this set of port IDs. For example, when the port information is port number information, N_port is the number corresponding to the port number information.

For example, the UE determines the CSI parameters of (associated with) the first reference signal resource according to the first spatial parameters associated with the first reference signal (resource).

For example, the UE receives indication information/configuration information (from the base station). For example, the UE receives information (from the base station) indicated/configured by the first information (for example, port information). For example, the UE receives information (from the base station) associated with the first information (for example, port information). For example, the port information may be or may include port ID information. For example, the port information may be or may include port number information. For example, the port information may be or may include information of a used port. For example, the port information may be or may include information of unused/muted ports. For example, the port information may be or may include CDM set information. One CDM group corresponds to/associates with one or more ports. For example, the port information may be or may include used CDM group information. For example, the port information may be or may include unused/muted CDM group information.

For example, the second spatial parameter may be or may include the number of ports N1 in the first dimension and the number of ports N2 in the second dimension and/or the parameter Ng. Ng is, for example, a parameter for indicating the number of panels.

For example, the first spatial parameter may be or may include the number of ports N1_subset in the first dimension and the number of ports N2_subset in the second dimension and/or the parameter Ng_subset. Ng_subset is, for example, a parameter for indicating the number of panels.

For example, the product of the number of ports (N1_subset) in the first dimension included in/associated with the first spatial parameter and the number of ports (N2_subset) in the second dimension included in/associated with the first spatial parameter is less than or equal to the product of the number of ports (N1) in the first dimension included in/associated with the second spatial parameter and the number of ports (N2) in the second dimension included in/associated with the second spatial parameter.

For example, the product of the number of ports (N1_subset) in the first dimension included in/associated with the first spatial parameter and the number of ports (N2_subset) in the second dimension included in/associated with the first spatial parameter has an integer multiple relationship (e.g., a multiple relationship with a power of 2) with the product of the number of ports (N1) in the first dimension included in/associated with the second spatial parameter.

For example, the number of ports (N1_subset) in the first dimension included in/associated with the first spatial parameter is less than or equal to the number of ports (N1) in the first dimension included in/associated with the second spatial parameter.

For example, the number of ports (N2_subset) in the second dimension included in/associated with the first spatial parameter is less than or equal to the number of ports (N2) in the second dimension included in/associated with the second spatial parameter.

For example, the number of ports (N1_subset) in the first dimension included in/associated with the first spatial parameter has an integer multiple relationship (for example, a multiple relationship with a power of 2) with the number of ports (N1) in the first dimension included in/associated with the second spatial parameter.

For example, the number of ports (N2_subset) in the second dimension included in/associated with the first spatial parameter has an integer multiple relationship (for example, a multiple relationship with a power of 2) with the number of ports (N2) in the second dimension included in/associated with the second spatial parameter.

For example, the parameter (Ng_subset) included in/associated with the first spatial parameter is less than or equal to the parameter (Ng) included in/associated with the second spatial parameter.

For example, the parameter (Ng_subset) included in/associated with the first spatial parameter has an integer multiple relationship (for example, a multiple relationship with a power of 2) with the parameter (Ng) included in/associated with the second spatial parameter.

The following describes how at least one of N1_subset, N2_subset and Ng_subset is determined by the port ID information, N1, N2, Ng and Ng_subset, by using the port information as port ID information, the first spatial parameter as number of ports N1_subset in the first dimension and number of ports N2_subset in the second dimension and/or the parameter Ng_subset.

For example, N1_subset is equal to N1.

For example, N1_subset is determined based on the (total) number of port IDs (port IDs corresponding to the information) in 0 (+3000) to N1-1 (+3000) (normalized port ID) corresponding to/associated with the port ID information. For example, the normalized port ID means that the value of the smallest (or largest) port ID in this set of port IDs (generated port ID) is subtracted from a set of port IDs corresponding to/associated with the port ID information. For example, N1_subset*N2_subset is determined based on the (total) number (N_total) of port IDs (port ID corresponding to the information) in 0 (+3000) to N1*N2-1 (+3000) (normalized port ID) corresponding to the port ID information. For example, N2_subset is determined based on N1_subset. For example, N2_subset=N_total/N1_subset. For example, N2_subset N_port/(2*Ng_subset*N1_subset). N_port may be the number of port IDs (for example, the (total) number of ports corresponding/associated with the port ID information). For example, N1_subset is equal to the (total) number of port IDs in 0 (+3000) to N1-1 (+3000) (normalized port ID) corresponding to the port ID information. For example, the port ID is 3000, 3001, 3004, 3005; 3008, 3009, 3012, 3013; N1=2; N2=2; Ng=2. Since the number of ports is 2 in the range of 3000 to 3001 (that is, 3000+N1-1), N1_subset=2. Since the number of ports is 2 in the range of 3000 to 3003 (that is, 3000+N1*N2-1), N2_subset=N_total/N1_subset=1. For example, the port ID is 3000, 3001, 3004, 3005; 3008, 3009, 3012, 3013; N1=2; N2=2; Ng=2, since the number of ports with normalized port ID (0, 1,4,5,8,9,12,13) in the range of 0 to 1 (i.e., N1-1) is 2, N1_subset=2.

For example, N1_subset is determined based on the corresponding/associated (maximum) consecutive port ID number of the port ID information. For example, N1_subset is determined based on the number of (maximum) consecutive port IDs corresponding/associated with the port ID information and N1. For example, N1_subset=N_con, where N_con represents the (maximum) number of consecutive port IDs corresponding to/associated with the port ID information. For example, N1_subset=min(N_con, N1), where N_con represents the (maximum) number of consecutive port IDs corresponding to/associated with the port ID information. For example, when the port ID is 3000, 3001, 3004, 3005, 3006, the maximum number of consecutive port IDs is 3.

For example, N2_subset is equal to N2.

For example, N2_subset is determined based on the (total) number of port IDs (port IDs corresponding to the information) in 0 (+3000) to N2-1 (+3000) (normalized port ID) corresponding to/associated with the port ID information. For example, the normalized port ID means that the value of the smallest (or largest) port ID in this set of port IDs (generated port ID) is subtracted from a set of port IDs corresponding to/associated with the port ID information. For example, N1_subset*N2_subset is determined based on the (total) number (N_total) of port IDs (port ID corresponding to the information) in 0 (+3000) to N1*N2-1 (+3000) (normalized port ID) corresponding to the port ID information. For example, N1_subset is determined based on N2_subset. For example, N1_subset=N_total/N2_subset. For example, N1_subset N_port/(2*Ng_subset*N2_subset). N_port may be the number of port IDs (for example, the (total) number of ports corresponding/associated with the port ID information). For example, N2_subset is equal to the (total) number of port IDs from 0 (+3000) to N2-1 (+3000) (normalized port ID) corresponding to the port ID information. For example, the port ID is 3000, 3001, 3004, 3005; 3008, 3009, 3012, 3013; N1=2; N2=2; Ng=2. Since the number of ports is 2 in the range of 3000 to 3001 (that is, 3000+N2-1), N2_subset=2. Since the number of ports is 2 in the range of 3000 to 3003 (that is, 3000+N1*N2-1), N1_subset=N_total/N2_subset=1. For example, the port ID is 3000, 3001, 3004, 3005; 3008, 3009, 3012, 3013; N1=2; N2=2; Ng=2, since the number of ports with normalized port ID (0, 1,4,5,8,9, 12,13) in the range of 0 to 1 (that is, 3000+N2-1) is 2, N2_subset=2.

For example, N2_subset is determined based on the corresponding/associated (maximum) consecutive port ID number of the port ID information. For example, N2_subset is determined based on the corresponding/associated (maximum) number of consecutive port IDs of the port ID information and N1. For example, N2_subset=N_con, where N_con represents the (maximum) number of consecutive port IDs corresponding to/associated with the port ID information. For example, N2_subset=min(N_con, N2), where N_con represents the (maximum) number of consecutive port IDs corresponding to/associated with the port ID information. For example, when the port ID is 3000, 3001, 3004, 3005, 3006, the maximum number of consecutive port IDs is 3.

In this example, the spatial parameters associated with the first reference signal (resource) can be (implicitly) determined according to the port indication information, thus reducing the signaling overhead generated by the indication of the related spatial parameters.

### Example 10

Here, it is illustrated that the port (or port subset) associated with the first reference signal (resource) is determined according to at least one of the first spatial parameter, the second spatial parameter and the port set associated with the first reference signal (resource). For example, the port (or port subset) associated with the first reference signal (resource) is determined according to the first spatial parameter and the second spatial parameter. For example, the port associated with the first reference signal is a subset of the ports corresponding/associated with the second spatial parameter. For example, the number of ports of the first reference signal (resource) refers to the ports of the first reference signal (for example, CSI-RS). For example, the port of the first reference signal (resource) is based on the parameters in the configuration information of the first reference signal resource (for example, nrofPorts in resourceMapping). That is, the ports (sets) associated with/corresponding to the first reference signal (resource) are 3000, 3001, . . . , 3000+j-1, where j is equal to the value of the parameter nrofPorts. For example, the port (or port subset) associated with the first reference signal (resource) is a part of the port (set) associated with/corresponding to with the first reference signal (resource).

For example, (all) port IDs in the ports (or port subsets) associated with the first reference signal (resource) are consecutive.

For example, the condition that the method in Example 10 may need to be satisfied is that the codebook type associated with the first reference signal (resource) is a multi-panel codebook. In other words, the condition means that the codebook type parameter (codebook Type) (based on RRC signaling) is set to “typeI-MultiPanel”.

For example, when the port information associated with the first reference signal (resource) is not provided/configured/indicated, the port associated with the first reference signal (resource) is determined according to the configured/indicated first and second spatial parameters. When the port information associated with the first reference signal (resource) is provided/configured/indicated, the port associated with the first reference signal (resource) is indicated (directly/explicitly) by the base station.

For example, the UE determines the CSI parameters of (associated with) the first reference signal resource according to the port (or port subset) associated with the first reference signal (resource). For example, when determining CSI parameters, the UE determines (assumes) that the port with the smallest index is port (3000+) 0, the port with the second smallest index is port (3000+) 1, and so on.

For example, the UE receives indication information/configuration information (from the base station). For example, the UE receives information (from the base station) indicated/configured by the first information (for example, port information). For example, the UE receives information (from the base station) associated with the first information (for example, port information). For example, the port information may be or may include port ID information. For example, the port information may be or may include port number information. For example, the port information may be or may include information of a used port. For example, the port information may be or may include information of unused/muted ports. For example, the port information may be or may include CDM group information. One CDM group corresponds to/associates with one or more ports. For example, the port information may be or may include used CDM group information. For example, the port information may be or may include unused/muted CDM group information.

For example, the UE receives indication information/configuration information (from the base station). For example, the UE receives information (from the base station) indicated/configured by the first information (for example, second spatial parameters). For example, the second spatial parameter may be or may include the number of ports N1 in the first dimension and the number of ports N2 in the second dimension and/or the parameter Ng. Ng is, for example, a parameter for indicating the number of panels.

For example, the UE receives indication information/configuration information (from the base station). For example, the UE receives information (from the base station) indicated/configured by the first information (for example, the first spatial parameter). For example, the first spatial parameter may be or may include a first parameter (Ng_subset) and/or a second parameter. The first parameter is, for example, a parameter for indicating the number of panels. The second parameter is, for example, a parameter (N_offset) for indicating an antenna port offset or a panel offset.

By using the first spatial parameter as the first parameter (Ng_subset) and the offset parameter, and the second spatial parameter as the number of ports N1 in the first dimension and the number of ports N2 in the second dimension and the parameter (Ng), how to determine the ports (or port subsets) associated with the first spatial parameter/first reference signal will be described.

For example, the port (or port subset) associated with the first spatial parameter/first reference signal is determined based on the first spatial parameter and/or the second spatial parameter. For example, the port (or port subset) associated with the first spatial parameter/first reference signal is determined based on at least one of the first parameter (Ng_subset), the offset parameter (N_offset), the number of ports in the first dimension associated with the second spatial parameter, the number of ports in the second dimension associated with the second spatial parameter, and the parameter (Ng) associated with the second spatial parameter. For example, the number of ports (or a subset of ports) associated with the first spatial parameter/first reference signal is determined based on the second spatial parameter (the associated number of ports N1 in the first dimension and number of ports N2 in the second dimension and the parameter (Ng)). For example, the number of ports (port subsets) associated with the first spatial parameter/first reference signal is determined based on the second spatial parameter (the associated number of ports N1 in the first dimension and number of ports N2 in the second dimension and/or the parameter (Ng)). For example, the port offset of the port (or port subset) associated with the first spatial parameter/first reference signal is determined based on the second spatial parameter (the associated number of ports N1 in the first dimension and number of ports N2 in the second dimension) and/or the first spatial parameter (the associated Ng_subset and/or the offset parameter).

For example, the ports (or port subsets) associated with the first spatial parameter/first reference signal are 3000+K_offset, 3000+K_offset+1, ···, 3000+K_offset+2*Ng_subset*N1*N2-1. K_offset is based on N_offset. For example, K_offset is based on at least one of N_offset, N1, N2 and N_subset. For example, K_offset=N_offset. For example, N_offset can be 0 or a positive integer. For example, N_offset can be one of 0, 3, 7 and 15. For example, K_offset=N_offset*2*N1*N2. For example, K_offset=N_offset*2*N1*N2*N_subset. For example, N_offset can be one of 0, 1, 2 and 3. For example, K_offset=(N_offset-1)*2*N1*N2. For example, K_offset=(N_offset-1)*2*N1*N2*N_subset. For example, N_offset can be one of 1, 2, 3 and 4. For example, Ng_subset can be at least one of 1, 2 and 4.

For example, the ports (or port subsets) associated with the first spatial parameter/first reference signal are K_offset, K_offset+1, . . . , K_offset+2*N1*N2*Ng_subset-1. K_offset is based on N_offset. For example, K_offset is based on at least one of N_offset, N1, N2 and N_subset. For example, K_offset=N_offset. For example, N_offset can be 0 or a positive integer. For example, N_offset can be one of 0, 3, 7 and 15. For example, K_offset=N_offset*2*N1*N2. For example, K_offset=N_offset*2*N1*N2*N_subset. For example, N_offset can be one of 0, 1, 2 and 3. For example, K_offset=(N_offset-1)*2*N1*N2. For example, K_offset=(N_offset-1)*2*N1*N2*N_subset. For example, N_offset can be one of 1, 2, 3 and 4. For example, Ng_subset can be at least one of 1, 2 and 4.

For example, the number of ports in the first dimension associated with/corresponding to the ports (or port subset) associated with the first spatial parameter/first reference signal is determined based on N1 (associated with the second spatial parameter). For example, the number of ports in the first dimension associated with/corresponding to the ports (or port subset) associated with the first spatial parameter/first reference signal is equal to N1 (associated with the second spatial parameter).

For example, the number of ports in the first dimension associated with/corresponding to the ports (or port subset) associated with the first spatial parameter/first reference signal is determined based on N2 (associated with the second spatial parameter). For example, the number of ports in the first dimension associated with/corresponding to the ports (or port subset) associated with the first spatial parameter/first reference signal is equal to N2 (associated with the second spatial parameter).

In this example, the port (or port subset) associated with the first reference signal (resource) can be (implicitly) determined according to the spatial parameters, thus reducing the signaling overhead generated by the related indication.

The third embodiment describes the reference signal resources for which the first information acts, or, when the reference signal resources satisfy what conditions, CSI parameters are determined. This enables the base station to flexibly arrange the reference signal resources acted by the first information, and improves the scheduling flexibility of the communication system.

### Embodiment 4

FIG. 4D illustrates a flowchart of a method 430 performed by a UE according to various embodiments of the present disclosure. The method 430 includes a step 431 and a step 432. At step 431, the UE receives first information from a network device, and at step 432, the UE determines a CSI parameter(s) associated with first CSI report(s) according to the first information; wherein the first CSI report satisfies at least one of the following conditions: the first CSI report(s) is periodic; the first CSI report(s) is semi-persistent; the first CSI report(s) is aperiodic; a report quantity of the first CSI report(s) is a specific quantity; and the first CSI report(s) is determined according to the first information.

The UE receives the first information (for indicating power parameter(s) and/or spatial parameter(s)) from the network device.

The UE determines the CSI parameter(s) associated with the first CSI report(s) according to the first information (or according to the first power parameter(s) and/or the first spatial parameter(s) determined by the first information). The (determining of) CSI parameter(s) may be (determining of) CSI feedback. The (determining of) CSI parameter(s) can also be (determining of) a report (that is, a CSI report) that carries the CSI parameter(s). For example, the method of determining the first power parameter(s) refers to Embodiment 1. For example, the method of determining the first spatial parameter(s) refers to Embodiment 2.

The determining of the CSI parameter(s) by the UE according to the first power parameter(s) and/or the first spatial parameter(s) means (can be understood as) that: if configured to report CQI index, in the CSI reference resource, the UE assumes the first power parameter(s) and/or the first spatial parameter(s) for the purpose of deriving CSI parameter(s). The CSI parameter(s) include, for example, at least one of CQI index(es), PMI(s) or RI(s). For example, the CSI parameter(s) are the CQI index(es). For example, if the PMI(s) and RI(s) are configured, the CSI parameter(s) are the CQI index(es), PMI(s) and RI(s).

The following describes what conditions the first CSI report(s) satisfies, or how the UE determines the first CSI report(s) after receiving the first information. For example, the UE determines the CSI parameter(s) associated with the first CSI report according to the first power parameter(s) and/or the first spatial parameter(s).

The first CSI report satisfies at least one of the following conditions:
the first CSI report is periodic;
the first CSI report is semi-persistent;
the first CSI report is aperiodic;
the report quantity of the first CSI report is a specific report quantity; and
the first CSI report is determined according to the first information.

For example, when the UE receives a signaling/information (for example, the signaling in Embodiment 8), which includes the first information and is also used to trigger one or more (semi-persistent) CSI report(s), the UE determines CSI parameter(s) associated with the one or more CSI report(s) (corresponding/associated CSI-RS resources (for channel measurement) associated with the one or more CSI report(s)) according to the first power parameter(s) and/or the first spatial parameter(s) indicated by the first information.

For example, when the UE receives a signaling/information (for example, the signaling in Embodiment 8), which includes the first information and is also used to trigger one or more (aperiodic) CSI report(s), the UE determines CSI parameter(s) associated with the one or more CSI report(s) (corresponding/associated CSI-RS resources (for channel measurement) associated with the one or more CSI report(s)) according to the first power parameter(s) and/or the first spatial parameter(s) indicated by the first information.

For example, (for example, in addition to this/in addition to the cases described above,) the UE receives the first information from the network device, and the UE determines the CSI parameter(s) associated with the periodic CSI report(s) according to the first information.

For example, (for example, in addition to this/in addition to the cases described above,) the UE receives the first information from the network device, and the UE determines the CSI parameter(s) associated with the semi-persistent CSI report(s) according to the first information.

For example, (for example, in addition to this/in addition to the cases described above,) the UE receives the first information from the network device, and the UE determines the CSI parameter(s) associated with the aperiodic CSI report(s) according to the first information.

For example, the UE receives the first information from the network device. According to the first information, the UE determines the CSI parameter(s) associated with the CSI report of a specific report quantity. For example, the specific report quantity refers to at least one of: CSI-RS resource indicator (CRI), RI, PMI and CQI;
CRI, RI, layer indicator (LI), PMI and CQI;
CRI, RI and codebook-related parameters (for example, i1);
CRI, RI, codebook-related parameters (for example, i1) and CQI; and
CRI, RI and CQI.

For example, the report quantity of the CSI report being CRI, RI, PMI and CQI means that the report quantity parameter of the CSI report (reportQuantity, or reportQuantity in CSI-ReportConfig) is set/configured as “cri-RI-PMI-CQI” (RRC signaling).

For example, the report quantity of the CSI report(s) being CRI, RI, LI, PMI and CQI means that the report quantity parameter of the CSI report(s) (reportQuantity, or reportQuantity in CSI-ReportConfig) is set/configured as “cri-RI-LI-PMI-CQI” (RRC signaling).

For example, the report quantity of the CSI report(s) being CRI, RI and i1 means that the report quantity parameter of the CSI report (reportQuantity, or reportQuantity in CSI-ReportConfig) is set/configured as “cri-RI-i1” (RRC signaling).

For example, the report quantity of the CSI report(s) being CRI, RI, i1 and CQI means that the report quantity parameter of the CSI report (reportQuantity, or reportQuantity in CSI-ReportConfig) is set/configured as “cri-RI-i1-CQI” (RRC signaling).

For example, the report quantity of CSI report(s) being CRI, RI and CQI means that the report quantity parameter of the CSI report (reportQuantity, or reportQuantity in CSI-ReportConfig) is set/configured as “cri-RI-CQI” (RRC signaling).

For example, the UE receives first information from the network device. When the report quantity of the first CSI report(s) is CRI, RI, PMI and CQI (or CRI, RI, LI, PMI and CQI), the UE determines the CSI parameter(s) associated with the first CSI report(s) according to the first information (or the first power parameter(s) and/or the first spatial parameter(s) determined by the first information).

For example, the UE receives the first information from the network device. When the report quantity of the first CSI report is CRI, RI and i1 (or CRI, RI, i1 and CQI), the UE determines the CSI parameter(s) associated with the first CSI report(s) according to the first information (or the first power parameter(s) and/or the first spatial parameter(s) determined by the first information).

For example, the UE receives the first information from the network device. When the report quantity of the first CSI report is CRI, RI and i1 (or CRI, RI, i1 and CQI) (and the codebook type associated with the first spatial parameter(s) is a single-panel codebook, and/or the associated PMI format indicator indicates a wideband PMI), the UE determines the CSI parameter(s) associated with the first CSI report(s) according to the first information (or the first power parameter(s) and/or the first spatial parameter(s) determined by the first information). For example, the codebook Type being a single-panel codebook means that the codebook type parameter is configured/set to “typel-SinglePanel”(by RRC signaling). For example, the PMI format indicator indicating the wideband PMI means that the PMI format indicator parameter (pmi-FormatIndicator) is configured/set to “widebandPMI” (by RRC signaling).

For example, the UE receives the first information from the network device. When the report quantity of the first CSI report is CRI, RI and i1 (or CRI, RI, i1 and CQI) (and the codebook type related to the first spatial parameter is not single-panel codebook, and/or the related PMI format indicator does not indicate wideband PMI), the UE does not determine the CSI parameter(s) related to the first CSI report(s) according to the first information (or the first power parameter(s) and/or the first spatial parameter(s) determined by the first information).

For example, the UE receives the first information from the network device. When the report quantity of the first CSI report(s) is CRI, RI and CQI (and/or in the absence of CRI report, CSI corresponds to at most 4 CSI-RS ports in a single resource without CRI report), the UE determines the CSI parameter(s) associated with the first CSI report according to the first information (or the first power parameter(s) determined by the first information).

For example, the UE receives the first information from the network device. When the report quantity of the first CSI report(s) is CRI, RI and CQI (and/or in the absence of CRI report, CSI corresponds to at most 4 CSI-RS ports in a single resource without CRI report), the UE determines the CSI parameter(s) associated with the first CSI report not according to the first information (or the first spatial parameter(s) determined by the first information).

For example, the UE receives the first information from the network device. When the first CSI report is a CSI report determined according to the first information, the UE determines the CSI parameter(s) associated with the first CSI report(s) according to the first information (or the first spatial parameter(s) determined by the first information). For example, the first CSI report(s) being the CSI report(s) determined according to the first information means that the first CSI report is indicated by the first information. For example, the first CSI report(s) being a CSI report(s) determined according to the first information means that the ID of the first CSI report(s) is associated with (or equal to) the ID of the CSI report(s) (for example, CSI report configuration) indicated by the first information.

The fourth embodiment describes the CSI report for what the first information acts, or, when the CSI report satisfies what conditions, the CSI parameters are determined. This enables the base station to flexibly arrange the CSI report indicated by the first information, and improves the scheduling flexibility of the communication system.

### Embodiment 5

FIG. 4E illustrates a flowchart of a method 440 performed by a UE according to various embodiments of the present disclosure. The method 440 includes a step 441 and a step 442. At step 441, the UE receives first information from a network device. At step 442, the UE applies first power parameter(s) and/or first spatial parameter(s) indicated by the first information in a first time resource; the first time resource(s) satisfies at least one of the following conditions: the first time resource(s) is determined according to the first information; the first time resource(s) is determined according to the time domain position of the signal or channel related to the first information; the first time resource is time resource(s) in the second time resource(s); the first time resource(s) is time resource(s) in the third time resource; the first time resource is a time resource in the fourth time resource; and the first time resource is a time resource in the fifth time resource.

The UE receives the first information (for indicating power parameter(s) and/or spatial parameter(s)) from the network device.

The UE uses/applies the first power parameter(s) and/or the first spatial parameter(s) determined according to the first information (or, according to the first power parameter(s) and/or the first spatial parameter(s) indicated by the first information) in the first time resource. For example, the first power parameter and/or the first spatial parameter is used to determine the CSI parameters. That is, the UE determines the CSI parameters in the first time resource according to the first power parameters and/or the first spatial parameters determined by the first information. determining of the CSI parameter may be determining of CSI feedback. The determining of the CSI parameter may also be determining of a report that carries the CSI parameter (that is, determining of a CSI report). For example, the CSI parameter may be CSI feedback. The CSI parameter may also be a report that carries the CSI parameter (that is, a CSI report). For example, the method of determining the first power parameter refers to Embodiment 1. For example, the method of determining the first spatial parameter refers to Embodiment 2.

For example, the UE (in the first time resource) determines the CSI parameter according to the first power parameter and/or the first spatial parameter.

For example, when the CSI reference resource is within the first time resource, the UE determines the CSI parameter according to the first power parameter and/or the first spatial parameter. For example, the CSI reference resource being within the first time resource means that the CSI reference resource is (completely) within the first time resource (that is, no part of the CSI reference resource is outside the first time resource).

For example, when signaling (for example, DCI; for another example, the physical downlink control channel (PDCCH) associated with DCI format) triggering the CSI report (associated with CSI parameters) is within the first time resource (and/or the CSI reference resource is within the first time resource), the UE determines the CSI parameter according to the first power parameter and/or the first spatial parameter. For example, the signaling triggering the CSI report (associated with CSI parameters) being within the first time resource means that the signaling triggering the CSI report (associated with CSI parameters) is (completely) within the first time resource (that is, no part of the signaling will be outside the first time resource).

For example, the UE (in the first time resource) determining the CSI parameter according to the first power parameter and/or the first spatial parameter means (can be understood as) that: in case that the UE is configured to report CQI index, in the CSI reference resource, the UE assumes the first power parameter and/or the first spatial parameter for the purpose of deriving CSI parameter. The CSI parameter is, for example, at least one of CQI index, PMI and RI. For example, the CSI parameter is the CQI index. For example, in case that PMI and RI are configured, the CSI parameter is CQI index, PMI and RI.

For example, the first time resource may be an application time of the first information. The first time resource can be determined by at least one of the following methods:

### Method 1

The first time resource is determined according to the first information.

### Method 2

The first time resource is determined according to the time domain position of the signal or channel related to the first information.

### Method 3

The first time resource is a time resource in the second time resource.

### Method 4

The first time resource is a time resource in the third time resource.

### Method 5

The first time resource is a time resource in the fourth time resource.

### Method 6

The first time resource is a time resource in the fifth time resource.

### Method 7

The first time resource is a time resource in the sixth time resource;

### Method 8

The first time resource is (or includes) the time resource of the channel or signal triggered by the first information.

### Example 1

Here, it is illustrated that the first time resource is determined according to the first information (explicitly). For example, the first time resource is (explicitly) indicated by the first information. For example, the UE receives time resource configuration information, and the UE determines the first time domain resources according to the configuration information (indicated parameters) and/or the first information (indicated parameters). For another example, the UE receives one or more time resource configuration information, and the UE determines the first time domain resources according to the configuration information indicated by the first information.

The first time resource is defined/determined by at least one of the following parameters (determined by the first information and/or the time resource configuration information):
One or more time unit indexes. For example, a slot index. For example, a symbol index.
   For example, the one or more time unit indexes are indicated by the first information.
   For example, the one or more time unit indexes are (pre-)configured (by RRC signaling). For example, a slot index. For example, a slot index list. For example, a slot index bitmap.
The start position of one or more time domain resources and one or more (corresponding) time domain resource lengths.
   For example, the start position refers to the start slot and/or the start symbol in the start slot.
      For example, the parameter is indicated by the first information.
      For example, this parameter is (pre-)configured (by RRC signaling).
      For example, the start slot position refers to the period of the first time resource (see the description of the first time resource period later). That is, the start slot position (may) be an offset to the period of the first time resource.
      For example, the start slot position refers to the system frame number (SFN). For example, SFN 0.
      For example, the position of the start slot refers to the slot in which the signal or channel carrying the first information is located. For example, for example, when the slot in which the DCI format carrying the first information (or the PDCCH corresponding to the DCI format) is located is slot n, and the slot offset indicated by the first information is k, the start slot of the first time domain resource is slot n+k or

$$⌊ n \cdot \frac{{2}^{{u}_{T}}}{{2}^{{u}_{D}}} ⌋ + k .$$

For example, u_{T} is the subcarrier spacing (SCS) (configuration) of the first time domain resource. For example, u_{D} is the SCS (configuration) of the PDCCH.
For example, the start slot position is a slot in which a signal or channel carrying feedback of the first information (for example, hybrid automatic repeat request-acknowledge (HARQ-ACK) information) is referenced. For example, for example, when the slot where the physical uplink control channel (PUCCH)/physical uplink shared channel (PUSCH) carrying the feedback of the first information is located is slot n, and the slot offset indicated by the first information is k, the start slot of the first time domain resource is slot

$$⌊ n \cdot \frac{{2}^{{u}_{T}}}{{2}^{{u}_{D}}} ⌋ + k .$$

For example, u_{T} is the SCS (configuration) of the first time domain resource. For example, u_{D} is SCS (configuration) of PUSCH or PUCCH.
For example, the start symbol position is the (first) symbol (or symbol 0) referring to the start slot.
For example, the length of the time domain resource is a slot or a symbol. For example, when the start position is the start slot, the corresponding time domain resource length is a specific slot. For another example, when the start position is the start slot and the start symbol in the start slot, the time domain resource length is the symbol.
   For example, the length of the time domain resource is indicated by the first information.
   For example, the length of time domain resources is (pre-)configured (by RRC signaling).
Subcarrier spacing. The subcarrier spacing is the subcarrier spacing (of time unit) of the first time domain resource.
   For example, the subcarrier spacing is (pre) configured by the base station (RRC signaling).
   For example, the subcarrier spacing is determined according to the carrier component (CC)/cell using/applying the first information. For example, the subcarrier spacing is determined according to the minimum/maximum (active) (downlink) BWP of the (active) BWP of the CC/cell to which the first information is applied.
      For example, the CC/cell that uses/applies the first information is (pre-)configured.
   For example, the subcarrier spacing is determined according to the subcarrier spacing (configuration) of the (active) (downlink) BWP/initial (downlink) BWP (of the cell) receiving the first information (or the channel carrying the first information).
   For example, the subcarrier spacing is determined according to the subcarrier spacing of the (active) BWP of the CC/cell that uses/applies the first information and the subcarrier spacing (configuration) of the (active) (downlink) BWP/initial (downlink) BWP (of the cell) that receives the first information (or the channel carrying the first information). For example, the subcarrier spacing is the smallest/largest subcarrier spacing therein.
   For example, the subcarrier spacing is indicated by the first information. For example, the first information includes reference subcarrier spacing information (indicating one of the preconfigured subcarrier spacings). The UE determines the subcarrier spacing according to the reference subcarrier spacing information.
   For example, the subcarrier spacing is predefined. For different frequency ranges, the corresponding (possible) values of SCS are different. For example, when the frequency range is frequency range 1 (FR1), the SCS is 15 or 30 kHz. When the frequency range is frequency range 2-1 (FR2-1) (or frequency range 2 (FR2)), the SCS is 60 or 120 KHz. When the frequency range is 2-2 (FR2-2), the SCS is 120 or 480 kHz.

For example, the first time domain resource has a specific (repetitive) period. The specific period is determined according to at least one of the following methods:

### Method 1

The period is (pre) configured by the base station (RRC signaling).

### Method 2

The subcarrier spacing is indicated by the first information. For example, the first information includes period information indicating one of the preconfigured periods. The UE determines the (repetitive) period of the first time resource according to the period information.

### Method 3

The period is the period of SSB. For example, the SSB period obtained by the UE by receiving common signaling (ssb-PeriodicityServingCell). For example, when the UE does not receive the period indication (for example, the period indication of Method 1 or Method 2), the period is determined by Method 3.

### Method 4

A period corresponding to physical random access channel (PRACH) occasion. For example, the period is determined according to a predefined rule (for example, the period is equal to the SSB period in Method 3). For example, when the UE does not receive the period indication (for example, the period indication of Method 1 or Method 2), the period is determined by Method 4.

### Method 5

A period of CSI-RS. For example, the period corresponding to the tracking reference signal (TRS). For example, when the UE does not receive the period indication (for example, the period indication of Method 1 or Method 2), the period is determined by Method 5.

### Method 6

The periodicity of the DL-UL pattern. For example, the period provided by dl-UL-TransmissionPeriodicity in TDD-UL-DL-ConfigCommon. For example, when the UE does not receive the period indication (for example, the period indication of Method 1 or Method 2), the period is determined by Method 6.

For example, the CSI reference resource being within the first time domain resource means that the CSI reference resource is (completely) within the first time domain resource indicated by the first information.

For example, the signaling triggering the CSI report (associated with CSI parameters) being in the first time resource means that the signaling triggering the CSI report (associated with CSI parameters) is (completely) in the first time resource.

It should be noted that time units can be symbols, slots and sub-slots. The time units can be frames, subframes, milliseconds, seconds and samples.

### Example 2

Here, it is illustrated that the first time resource is determined according to (the time domain position of) the signal or channel related to the first information.

For example, the (start position of) first time resource is determined according to the time domain position of the signal or channel carrying the first information.

For example, the (start position of) first time resource is determined according to the time domain position of the signal or channel carrying the feedback of the first information (for example, HARQ-ACK information).

The (start position of) first time resource is defined/determined by at least one of the following parameters (determined by the first information):
First time resource (start position/start time unit). This parameter is determined according to at least one of the following methods:
   Method 1. The first time resource (start position/start time unit) is determined according to the signal or channel carrying the first information (for example, DCI format carrying the first information or the PDCCH corresponding to DCI format carrying the first information).
      For example, the start time unit of the first time resource is after (X time units of) the signal or channel carrying the first information.
         For example, X time units are time for processing the first information. For example, X time units are the time used for the first information to apply.
         For example, X time units are predefined. For example, 3 milliseconds. For example, 28 symbols. For example, the method of determining X is the same as that of determining N in Embodiment 8.
         For example, X is determined based on the UE PDSCH processing procedure time. For example, parameter T_{proc,1}. For example, the UE PDSCH processing procedure time (T_{proc,1}) for UE processing capability 1. For example, the UE PDSCH processing procedure time (T_{proc,1}) for UE processing capability 2.
         For example, X is determined based on the UE PUSCH preparation procedure time. For example, parameter T_{proc,2}. For example, the UE PUSCH preparation procedure time (T_{proc,2}) for UE processing capability 1. For example, the UE PUSCH preparation procedure time (T_{proc,2}) for UE processing capability 2.
         For example, X is determined based on (reported) UE capabilities. For example, X is determined according to the UE capability report reported by the UE.
         For example, X is (pre-)configured (by RRC signaling).
         For example, the time unit is, for example, a symbol/slot. For example, the time unit is, for example, milliseconds.
   Method 2. The first time resource (start position/start time unit) is determined according to a signal or channel (e.g., PUCCH/PUSCH) carrying feedback of the first information (e.g., HARQ-ACK).
      For example, the start time unit of the first time resource is after (X time units of) the signal or channel carrying the feedback of the first information.
         For example, X time units are time for processing the first information. For example, X time units are the time used for the first information to apply.
         For example, X time units are predefined. For example, 3 milliseconds. For example, 28 symbols. For example, the method of determining X is the same as that of determining N in Embodiment 8.
         For example, X is based on (reported) UE capabilities. For example, X is determined according to the UE capability report reported by the UE.
         For example, X is (pre-)configured (by RRC signaling).
         For example, the time unit is a symbol/slot. For example, the time unit is milliseconds.
Subcarrier spacing. For example, the subcarrier spacing is the subcarrier spacing (of time unit) of the first time resource (start time unit). For example, the subcarrier spacing is (also) a subcarrier spacing of X time units.
   For example, the subcarrier spacing is (pre-)configured by the base station (RRC signaling).
   For example, the subcarrier spacing is determined according to the CC/cell that uses/applies the first information. For example, the subcarrier spacing is determined according to the minimum/maximum (active) (downlink) BWP of the CC/cell to which the first information is applied.
      For example, the CC/cell that uses/applies the first information is (pre-)configured.
   For example, the subcarrier spacing is determined according to the subcarrier spacing (configuration) of the (active) (downlink) BWP/initial (downlink) BWP (of the cell) receiving the first information (or the channel carrying the first information).
   For example, the subcarrier spacing is determined according to the subcarrier spacing of the (active) BWP of the CC/cell that uses/applies the first information and the subcarrier spacing (configuration) of the (active) (downlink) BWP/initial (downlink) BWP (of the cell) that receives the first information (or the channel carrying the first information). For example, the subcarrier spacing is the smallest/largest subcarrier spacing therein.
   For example, the subcarrier spacing is indicated by the first information. For example, the first information includes reference subcarrier spacing information (indicating one of the preconfigured subcarrier spacings). UE determines the subcarrier spacing according to the reference subcarrier spacing information.
   For example, the subcarrier spacing is predefined. For different frequency ranges, the corresponding (possible) values of SCS are different. For example, when the frequency range is FR1, the SCS is 15 or 30 kHz. When the frequency range is FR2-1 (or FR2), the SCS is 60 or 120 kHz. When the frequency range is FR2-2, the SCS is 120 or 480 kHz.

For example, the (end position of) first time resource is determined according to the (time domain position of) related signal or channel of the next first information. For example, the (end position of) first time resource is determined according to the next effective time of the first information. For example, the (end position of) first time resource is determined according to the (time domain start position of) related signal or channel of the next first information. The method of determining the (time domain position of) related signal or channel of the first information next time refers to the above.

For example, the CSI reference resource (the first symbol of the slot/) being within the first time domain resource means that the CSI reference resource is (X time units) after the (latest) signal or channel carrying the first information (or the feedback of the first information) (and/or before the first information applies next time).

For example, the signaling triggering the CSI report (associated with CSI parameters) within the first time resource means that the signaling triggering the CSI report (associated with CSI parameters) is (completely) after (X time units) the (latest) signal or channel carrying the first information (or feedback of the first information) (and/or before the next first information applies).

It should be noted that time units can be symbols, slots, and sub-slots. The time units can be frames, subframes, milliseconds, seconds, and samples.

### Example 3

Here, it is illustrated that the first time resource is a time resource in the second time resource. For example, the first time resource being a time resource in the second time resource means that the first time resource is the second time resource.

For example, the second time resource is a time resource for a subband non-overlapped full duplex operation (SBFD).

For example, the second time resource is determined by (SBFD) configuration information.

For example, the (SBFD) configuration information also provides a (corresponding) first frequency domain resource for uplink transmission. For example, the UE may perform uplink transmission (or transmit uplink signals or channels) on the second time resource (and/or in a downlink time unit and/or a flexible time unit (indicated by TDD configuration information)) on the first frequency domain resource. Here, the time unit is, for example, a symbol or a slot. For example, the TDD configuration information is, for example, common TDD configuration information (for example, tdd-UL-DL-ConfigurationCommon. Another example of TDD configuration information is (UE-specific/specific) TDD configuration information, tdd-UL-DL-ConfigurationDedicated).

For example, the (SBFD) configuration information also provides a (corresponding) first frequency domain resource for downlink transmission. For example, the UE may perform downlink reception (or receive downlink signals or channels) on a second time resource (and/or in an uplink time unit and/or a flexible time unit (indicated by TDD configuration information)) on a second frequency domain resource. Here, the time unit is, for example, a symbol or a slot. For example, the TDD configuration information refers to common TDD configuration information (for example, tdd-UL-DL-ConfigurationCommon. Another example of TDD configuration information is (UE-specific/specific) TDD configuration information, tdd-UL-DL-ConfigurationDedicated).

For example, when the CSI reference resource being within the first time domain resource means (can be understood as) that the CSI reference resource is within the second time domain resource.

For example, the signaling triggering the CSI report (associated with CSI parameters) being in the first time resource means that the signaling triggering the CSI report (associated with CSI parameters) is in the second time resource.

It should be noted that time units can be symbols, slots, and sub-slots. The time units can be frames, subframes, milliseconds, seconds, and samples.

### Example 4

Here, it is illustrated that the first time resource is a time resource in the third time resource. For example, the first time resource being the time resource in the third time resource means that the first time resource is the third time resource.

For example, the third time resource is a non-second time resource. For example, the third time resource is a time resource other than the second time resource.

For example, when the CSI reference resource being within the first time domain resource means (can be understood as) that the CSI reference resource is within the third time domain resource.

For example, the signaling triggering the CSI report (associated with CSI parameters) being in the first time resource means that the signaling triggering the CSI report (associated with CSI parameters) is in the third time resource.

### Example 5

Here, it is illustrated that the first time resource is a time resource in the fourth time resource. For example, the first time resource being the time resource in the fourth time resource means that the first time resource is the fourth time resource.

For example, the fourth time resource refers to the cell discontinuous transmission (DTX) inactive time.

For example, the fourth time resource refers to a cell discontinuous reception (DRX) inactive time.

For example, the fourth time resource is a time domain resource for cell (or network) energy saving.

For example, in the fourth time resource, the cell (or the network) is off (or in an off mode and in an off state). For example, in the fourth time resource, the cell (or the network) is asleep (or in a sleep mode and in a sleep state). For example, in the fourth time resource, the cell (or the network) is inactive (or in an inactive mode and in an inactive state).

For example, in the fourth time resource (e.g., cell DTX inactive time), the cell (or the network) does not transmit (specific) downlink channels and/or signals (or the UE does not receive (specific) downlink channels and/or signals). The specific downlink channel and/or signal refers to at least one of:
Channels or signals other than SSB;
CSI-RS;
Demodulating the reference signal (DM-RS);
PDSCH;
PDCCH; and
SSB.

For example, in the fourth time resource (e.g., cell DRX inactive time), the cell (or the network) does not receive (specific) uplink channels and/or signals (or the UE does not transmit (specific) uplink channels and/or signals). The specific uplink channel and/or signal refers to at least one of:
Sounding reference signal (SRS);
DM-RS;
Physical random access channel (PRACH);
PUSCH; and
PUCCH.

For example, when the CSI reference resource being within the first time domain resource means (can be understood as) that the CSI reference resource is within the fourth time domain resource.

For example, the signaling triggering the CSI report (associated with CSI parameters) being in the first time resource means that the signaling triggering the CSI report (associated with CSI parameters) is in the fourth time resource.

### Example 6

Here, it is illustrated that the first time resource is a time resource in the fifth time resource. For example, the first time resource being the time resource in the fifth time resource means that the first time resource is the fifth time resource.

For example, the fifth time resource is a non-fourth time resource. For example, the fifth time resource is a time resource other than the fourth time resource.

For example, the fifth time resource refers to the cell DTX active time.

For example, the fifth time resource refers to the cell DRX active time.

For example, the fifth time resource is a time domain resource for cell (or network) energy saving.

For example, in the fifth time resource, the cell (or the network) is on (or in an on mode and in an on state). For example, in the fifth time resource, the cell (or the network) is awake (or in an awake mode and in an awake state). For example, in the fifth time resource, the cell (or the network) is active (or in an active mode, in an active state).

For example, in the fifth time resource, the cell (or the network) transmits (specific) downlink channels and/or signals (or the UE receives (specific) downlink channels and/or signals). The specific downlink channel and/or signal refers to at least one of:
CSI-RS;
DM-RS;
PDSCH;
PDCCH; and
SSB.

For example, in the fourth time resource, the cell (or the network) receives (specific) uplink channels and/or signals (or the UE transmits (specific) uplink channels and/or signals). The specific uplink channel and/or signal refers to at least one of:
SRS;
DM-RS;
PRACH;
PUSCH; and
PUCCH.

For example, when the CSI reference resource being within the first time domain resource means (can be understood as) that the CSI reference resource is within the fifth time domain resource.

For example, the signaling triggering the CSI report (associated with CSI parameters) being in the first time resource means (can be understood as) that the signaling triggering the CSI report (associated with CSI parameters) is in the fifth time resource.

### Example 7

Here, it is illustrated that the first time resource is a time resource in the sixth time resource. For example, the first time resource being the time resource in the sixth time resource means that the first time resource is the sixth time resource.

For example, the sixth time resource refers to UE DRX active time or UE DRX inactive time.

For example, when the CSI reference resource being within the first time domain resource means (can be understood as) that the CSI reference resource is within the sixth time domain resource. For example, when the CSI reference resource being within the first time domain resource means (can be understood as) that the CSI reference resource is within the UE DRX active time or the UE DRX inactive time.

For example, the signaling triggering the CSI report (associated with CSI parameters) being in the first time resource means (can be understood as) that the signaling triggering the CSI report (associated with CSI parameters) is in the sixth time resource.

For example, the signaling triggering the CSI report (associated with CSI parameters) being within the first time resource means (can be understood as) that the signaling triggering the CSI report (associated with CSI parameters) is within UE DRX active time or UE DRX inactive time.

### Example 8

Here, it is illustrated that the first time resource is (or includes) the time resource of the channel or signal triggered by the first information. For example, the channel or signal includes at least one of PDSCH, CSI-RS, PUSCH, PUCCH and SRS. For example, the channel or signal triggered by the first information refers to the channel or signal triggered by the DCI format associated with the first information (for example, the DCI format carrying the first information).

For example, when the CSI reference resource being within the first time domain resource means (can be understood as) that the CSI reference resource is within the time resource of the channel or signal triggered by the first information.

For example, the signaling triggering the CSI report (associated with CSI parameters) being in the first time resource means (can be understood as) that the signaling triggering the CSI report (associated with CSI parameters) is in the time resource of the channel or signal triggered by the first information.

In the present disclosure, time resources may be referred to as time or time period.

For example, the first time resource may be called the first time or the first time period.

For example, the second time resource may be called a second time or a second time period.

For example, the third time resource may be called the third time or the third time period.

For example, the fourth time resource may be called the fourth time or the fourth time period.

For example, the fifth time resource may be called the fifth time or the fifth time period.

For example, the sixth time resource may be called the sixth time or the sixth time period.

The fifth embodiment provides a method for determining the action time of the first information. The method enables the base station to flexibly arrange the action time of the first information, and improves the scheduling flexibility of the communication system.

### Embodiment 6

FIG. 4F illustrates a flowchart of a method 450 performed by a UE according to various embodiments of the present disclosure. The method 450 includes a step 451 and a step 452. At step 451, the UE receives first information from a network device. At step 452, the UE updates a specific number of CSI reports with a high priority (or is not required to update a specific number of CSI reports with a low priority). The specific number is determined according to the first information (determined first spatial parameter).

The UE indicates the number of supported simultaneous CSI calculations N_{CPU} with parameter simultaneousCSI-ReportsPerCC in a component carrier, and simultaneousCSI-ReportsAllCC across all component carriers.

If a UE supports N_{CPU} simultaneous CSI calculations the UE is said to have N_{CPU} CSI processing units for processing CSI reports. If L CPUs are occupied for calculation of CSI reports in a given OFDM symbol, the UE has N_{CPU}-L unoccupied CPUs.

If N CSI reports start occupying their respective CPUs on the same OFDM symbol on which N_{CPU}-L CPUs are unoccupied, where each CSI report n=0, . . . , N-1 corresponds to O_{CPU}(n), the UE is not required to update the N-M requested CSI reports with lowest priority, where O≤M≤N is the largest value such that Σₙ₌₀^{M-1}O_{CPU}(n)≤N_{CPU}-L holds.

The UE receives the first information (for indicating power parameter(s) and/or spatial parameter(s)) from the network device. For example, the first spatial parameter(s) is determined according to the first information. The method of determining the first spatial parameter(s) refers to Embodiment 2.

When a CSI report satisfies a specific condition, O_{CPU} is determined according to the first spatial parameter(s) and/or the first power parameter(s), or O_{CPU}=N_{CPU}. The specific condition refers to at least one of:
CSI reference resources associated with the CSI report are in one or more time units. The (indexes of) one or more time units are determined according to the first information. The time units are, for example, slots or symbols.
A CSI report is aperiodically triggered.
A CSI report is without transmitting a PUSCH with either transport block or HARQ-ACK or both.
L=0 CPUs are occupied.
The CSI corresponds to a single CSI with wideband frequency-granularity.
The CSI corresponds to at most 4 CSI-RS ports in a single resource.
The CSI (of the CSI report) without CRI report.
The report quantity of CSI is CRI, RI and CQI. The report quantity of CSI being CRI, RI and CQI means that the report quantity parameter of the CSI report (reportQuantity, or reportQuantity in CSI-ReportConfig) is set/configured as “cri-RI-CQI” (by RRC signaling).
The codebook type associated with/corresponding to the first spatial parameter(s) is type 1 single panel. For example, the codebook type parameter (codebookType) associated with the first spatial parameter(s) is set/configured as “typeI-SinglePanel” (by RRC signaling).
The DCI format (or the PDCCH corresponding to the DCI format) (the time unit) that triggers the CSI report is after (X time units of) the signal or channel carrying the (latest) first information (or the feedback carrying the first information) (or, the signal or channel carrying the first information (or the feedback carrying the first information) is not later than the DCI format that triggers the CSI report). The description of the signal or channel carrying the first information (or the feedback carrying the first information) and X (time units) refers to Embodiment 5.
The CSI reference resource (in the time unit) reported by the CSI is after (X time units of) the signal or channel carrying the (latest) first information (or the feedback of the first information) (or the signal or channel carrying the first information (or the feedback of the first information) is not later than the CSI reference resource reported by the CSI). The description of the signal or channel carrying the first information (or the feedback carrying the first information) and X (time units) refers to Embodiment 5.

For example, the first number (for example, O_{CPU}) being determined according to the first spatial parameter(s) means that the first number is determined according to the number of reference signals (resources) associated with the first spatial parameter(s). For example, the first number (for example, O_{CPU}) is equal to the number of reference signals (resources) associated with the first spatial parameter(s). For example, the reference signal(s) (resource(s)) refers to a number of reference signal(s) (resource(s)) in the reference signal (resource) set (used for channel measurement).

For example, the first number (for example, O_{CPU}) being determined according to the first spatial parameter(s) and/or the first power parameter(s) means that when the reference signal(s) (resource(s)) (each in the reference signal resource set) are associated with/correspond to a first spatial parameter and/or a first power parameter, the first number is determined according to the number of reference signals (resources). For example, the first number (for example, O_{CPU}) is equal to the number of reference signal(s) (resource(s)) (in the reference signal resource set). For example, the reference signal (resource) refers to the reference signal (resource) in the reference signal (resource) set (used for channel measurement).

For example, the first number (for example, O_{CPU}) being determined according to the first spatial parameter(s) and/or the first power parameter(s) means that the first number is determined according to at least one of the number of reference signal(s) (resource(s)) (within reference signal resource set), the number of first power parameter(s) associated with reference signal(s) (each in the reference signal resource set) and the number of first spatial parameter(s) associated with reference signals (each in the reference signal resource set). For example, the reference signal(s) (resource(s)) refers to the reference signal(s) (resource(s)) in the reference signal (resource) set (used for channel measurement).

For example, the first number (for example, O_{CPU}) being determined according to the first spatial parameter and/or the first power parameter means that when the reference signals (resources) (each in the reference signal resource set) are associated with/correspond to at least one first spatial parameter(s) and/or at least one first power parameter(s), the first number is determined according to the number of reference signal(s) (resource(s)) (reference signal resource(s)), the number of first power parameter(s) associated with reference signal(s) (each in the reference signal resource set) and the number of first spatial parameter(s) associated with reference signal(s) (each in the reference signal resource set). For example, the reference signal(s) (resource(s)) refers to the reference signal (resource(s)) in the reference signal (resource) set (used for channel measurement).

Embodiment 6 provides a method for the UE to determine CPU. The method enables the base station and the UE to have a unified understanding of the number of CPUs, prevents the UE from mistakenly dropping CSI reports, and improves the stability of the communication system.

### Embodiment 7

FIG. 4G illustrates a flowchart of a method 460 performed by a UE according to various embodiments of the present disclosure. The method 460 includes: at 461, the UE receives first information from a network device; at 462, in one time unit, the UE is not expected to have more CSI-RS ports than reported as capability; the number of the CSI-RS ports is determined according to first spatial parameter(s) determined by the first information.

For example, the UE reports (also to the network device) the number of active CSI-RS ports (supported by the UE) in the active BWP(s).

The UE receives the first information (for indicating power parameter(s) and/or spatial parameter(s)) from the network device.

In any slot, the UE is not expected to have more active CSI-RS ports (in active BWPs) than reported as capability. For example, in any time unit (e.g., slot), (UE determines that) the active CSI-RS ports are not more than the number of active CSI-RS ports than reported as capability.

The number of active CSI-RS ports is determined as follows.

If the above-mentioned time unit is (completely) within the first time resource, the number of active CSI-RS ports is determined according to the first spatial parameters (or determined according to the first spatial parameter(s) indicated by the first information). For example, the method of determining the first time resource refers to Embodiment 5. For example, the method of determining the first spatial parameter(s) refers to Embodiment 2.

For example, the number of active CSI-RS ports being determined according to first spatial parameter(s) means that for a CSI-RS resource, the number of active CSI-RS ports is equal to the number of (CSI-RS) ports (associated with/corresponding to/provided by) the first spatial parameter(s).

For example, the number of active CSI-RS ports being determined according to the first spatial parameter(s) means that for a CSI-RS resource, the number of active CSI-RS ports is determined according to (the smaller/larger/smallest/largest port number among) the number of (CSI-RS) ports of the CSI-RS resource and the number of (CSI-RS) ports (associated with/corresponding to/provided by) the first spatial parameter(s).

For example, the number of active CSI-RS ports being determined according to the first spatial parameter(s) means that for a CSI-RS resource, the number of active CSI-RS ports is equal to the smaller/larger/smallest/largest port number according to the number of (CSI-RS) ports of the CSI-RS resource and the number of (CSI-RS) ports (associated with/corresponding to/provided by) the first spatial parameter(s).

For example, the above method for determining the active CSI-RS ports is (can be) used for aperiodic CSI-RS.

For example, the above method for determining the active CSI-RS ports is (can be) used for semi-persistent CSI-RS.

For example, the above method for determining the active CSI-RS ports is (can be) used for periodic CSI-RS.

For example, the method for determining (number of) (CSI-RS) ports of CSI-RS resources and the method for determining (number of) (CSI-RS) ports (associated with/corresponding to/provided by) the first spatial parameter(s) refers to Embodiment 3 (Embodiment 3, Example 7).

Embodiment 7 provides a method for the UE to determine the active CSI-RS ports. The method enables the base station and the UE to have a common understanding of the number of active CSI-RS ports, prevents the number of active CSI-RS ports from exceeding the number of CSI-RS ports supported by the UE, and improves the stability of the communication system.

### Embodiment 8

FIG. 4H illustrates a flowchart of a method 470 performed by a UE according to various embodiments of the present disclosure. The method 470 includes a step 471 and a step 472. At step 471, the UE receives a first signaling from a network device, wherein the first signaling includes one or more first information. At step 472, the UE determines CSI parameter(s) according to one or more first information.

The UE receives the first signaling from the network device. The first signaling includes one or more first information (for indicating power parameter(s) and/or spatial parameter(s)). For example, the one or more first information are jointly encoded in the first signaling. For example, the one or more first information are separately encoded in the first signaling. For example, the first information includes power information and/or spatial information (used to determine the first power parameter and/or the first spatial parameter, respectively). For example, the power information and the spatial information (in the first information or the first signaling) are jointly encoded. For example, the power information and the spatial information (in the first information or the first signaling) are separately encoded.

The UE determines the CSI parameter(s) associated with the first reference signal(s) (resource(s)) according to the first information (or according to the first power parameter(s) and/or the first spatial parameter(s) determined by the first information). The (determining of) CSI parameter(s) may be (determining of) CSI feedback. The (determining of) CSI parameter(s) can also be (determining of) report(s) (that is, (determining of) a CSI report(s)) that carries the CSI parameter(s). For example, the method of determining the first power parameter(s) refers to Embodiment 1. For example, the method of determining the first spatial parameter(s) refers to Embodiment 2.

The following describes the first signaling by way of example.

### Example 1

In this example, the first signaling is first DCI (format). The first signaling carries/includes the first information.

For example, the first DCI is set common DCI.

For example, the first DCI is downlink DCI. For example, DCI format 1_1. For example, DCI format 1_2.

For example, the first DCI is uplink DCI. For example, DCI format 0_1. For example, DCI format 0_2.

For example, (when the first DCI is downlink DCI), the first DCI is (may be) with or without DL assignment.

For example, (when the first DCI is an uplink DCI), the first DCI is (may be) with or without UL assignment.

For example, when the first DCI is not with DL assignment (or UL assignment), the first DCI has at least one of the following characteristics:
A configured scheduling-radio network temporary identifier (CS-RNTI) is used to scramble the CRC for the first DCI.
Values of the DCI field of the first DCI are set as follows:
   All bits of the RV field are set to 1 (RV=all ‘1’s).
   All bits of the MCS field are set to 1 (MCS=all ‘1’s).
   All bits of the MCS field are set to 0 (MCS=all ‘0’s). So that the first DCI can be distinguished from the DCI format used for TCI state update.
   The bits of the NDI field are set to 0 (NDI=0).
   FDRA field:
      Set to all ‘0’s for FDRA Type 0.
      Set to all ‘1’s for FDRA Type 1.
      Set to all ‘0’s for dynamicSwitch.

For example, the first DCI includes a specific field for providing the first information (for example, including power information and spatial information). For example, the specific field is TCI field (when the first DCI is not with DL assignment (or UL assignment)).

For example, a specific field is included in the first DCI for providing power information (for example, the power information in the first information). For example, the specific field is a TPC command field (when the first DCI does not carry downlink allocation (or uplink allocation).

For example, the first DCI includes a specific field for providing spatial information (for example, spatial information in the first information). For example, the specific field is TCI field (when the first DCI is not with DL assignment (or UL assignment).

For example, the UE reports the HARQ-ACK information in response to the first DCI. For example, (the UE expects that) the HARQ-ACK information is after the first DCI (of the last symbol of the associated PDCCH) (N time units). The time units are, for example, symbols/slots.

The method of determining N is described below.

(When the processing type enabling parameter (of the cell where the first DCI is located) (for example, processing Type 2Enabled of PDSCH-ServingCellConfig) is configured to be enabled,) the value of N is at least one of:
(when μ=0) N=5;
(when μ=1) N=5.5; and
(when μ=2) N=11,

(When the processing type enabling parameter (of the cell where the first DCI is located) (processing Type 2Enabled of PDSCH-ServingCellConfig) is not configured to be enabled,) (or in other cases) the value of N is at least one of:
(when μ=0) N=10;
(when μ=1) N=12;
(when μ=2) N=22;
(when μ=3) N=25;
(when μ=5) N=100; and
(when μ=6) N=200.

For example, μ corresponds to (refers to) the smallest SCS configuration between the SCS configuration of the PDCCH providing the SPS PDSCH release and the SCS configuration of a PUCCH carrying the HARQ-ACK information in response to a SPS PDSCH release.

For example, μ corresponds to (refers to) the carrier spacing (configuration) of CC/cell that uses/applies the first information carried by the first DCI. For example, μ is determined according to the subcarrier spacing (configuration) of the minimum/maximum (active) (downlink) BWP of the CC/cell to which the first information is applied.

For example, μ corresponds to (refers to) the subcarrier spacing (configuration) of the (active) (downlink) BWP/initial (downlink) BWP (of the cell) receiving the first DCI (or transmitting the feedback of the first DCI).

For example, μ corresponds to (refers to) the subcarrier spacing of (active) (downlink) BWP of CC/cell using/applying the first information and the subcarrier spacing (configuration) of (active) (downlink) BWP/initial (downlink) BWP (of the cell) receiving the first information (or the channel carrying the first information). For example, the subcarrier spacing is the smallest/largest subcarrier spacing therein.

### Example 2

In this example, the first signaling is the first MAC-CE.

For example, the first MAC-CE includes a specific field for providing the first information (for example, including power information and spatial information).

For example, a specific field is included in the first MAC-CE for providing power information (for example, the power information in the first information).

For example, the first MAC-CE includes a specific field for providing spatial information (for example, the spatial information in the first information).

Embodiment 8 provides the signaling design for the first information, so that the UE can correctly interpret the first information and improve the reliability of the system.

### Embodiment 9

FIG. 4I illustrates a flowchart of a method 480 performed by a UE according to various embodiments of the present disclosure. The method 480 includes a step 481 and a step 482. At step 481, the UE receives CSI report configuration parameter(s). At step 482, the UE determines CSI parameter(s) without averaging at least two time instances of a reference signal (resource). The at least two time instances are not all in a first time resource.

The UE receives the CSI report configuration parameter (for example, CSI-ReportConfig). For example, the CSI report corresponds to a specific report quantity. For example, the specific report quantity refers to at least one of: CRI, RI, PMI and CQI; CRI, RI, LI, PMI and CQI; CRI, RI and i1; CRI, RI, i1 and CQI; CRI, RI and CQI.

For example, the report quantity of the CSI report being CRI, RI, PMI and CQI means that the report quantity parameter of the CSI report (reportQuantity, or reportQuantity in CSI-ReportConfig) is set/configured as “cri-RI-PMI-CQI” (by RRC signaling).

For example, the report quantity of the CSI report being CRI, RI, LI, PMI and CQI means that the report quantity parameter of the CSI report (reportQuantity, or reportQuantity in CSI-ReportConfig) is set/configured as “cri-RI-LI-PMI-CQI” (by RRC signaling).

For example, the report quantity of the CSI report being CRI, RI and i1 means that the report quantity parameter of the CSI report (reportQuantity, or reportQuantity in CSI-ReportConfig) is set/configured as “cri-RI-i1” (by RRC signaling).

For example, the report quantity of the CSI report being CRI, RI, i1 and CQI means that the report quantity parameter of the CSI report (reportQuantity, or reportQuantity in CSI-ReportConfig) is set/configured as “cri-RI-i1-CQI” (by RRC signaling).

For example, the report quantity of the CSI report being CRI, RI and CQI means that the report quantity parameter of the CSI report (reportQuantity, or reportQuantity in CSI-ReportConfig) is set/configured as “cri-RI-CQI” (by RRC signaling).

The UE derives CSI parameters without averaging two or more instances of the reference signal (resource). For example, the reference signal (resource) is a non-zero power CSI-RS (NZP CSI-RS) (resource) (among CSI-RS resources in the CSI-RS set associated with the report) (used for channel measurement and/or interference measurement). For example, the reference signal resource is (NZP) CSI-RS (resource) in the CSI-RS set used for channel measurement and/or interference measurement associated with the report. For example, the reference signal resource is CSI interference measurement (CSI-IM) (resource). For example, the reference signal (resource) is periodic or semi-persistent. For example, the reference signal (resource) is aperiodic.

For example, at least two time instances are not all in the first time resource. For example, the first time resource corresponds to/is associated with the same first information. For example, at least two time instances are not all in the first time resource (corresponding to the same first information).

For example, the description of the first time resource refers to Embodiment 5.

Embodiment 9 provides a method for determining CSI parameters, so that UE can generate accurate CSI parameters and improve the accuracy of CSI feedback.

### Embodiment 10

FIG. 4J illustrates a flowchart of a method 490 performed by a UE according to various embodiments of the present disclosure. The method 490 includes a step 491 and a step 492. At step 491, the UE receives a CSI configuration parameter(s). At step 492, the UE determines CSI parameter(s) according to a reference signal measured at a specific time; wherein the specific time is the first time resource.

The UE receives the CSI report configuration parameter (for example, C′SI-ReportConfig). For example, the CSI report corresponds to a specific report quantity. For example, the specific report quantity refers to at least one of: CRI, RI, PMI and CQI; CRI, RI, LI, PMI and CQI; CRI, RI and i1; CRI, RI, i1 and CQI; CRI, RI and CQI.

For example, the report quantity of the CSI report being CRI, RI, PMI and CQI means that the report quantity parameter of the CSI report (reportQuantity, or reportQuantity in CSI-ReportConfig) is set/configured as “cri-RI-PMI-CQI” (by RRC signaling).

For example, the report quantity of the CSI report being CRI, RI, LI, PMI and CQI means that the report quantity parameter of the CSI report (reportQuantity, or reportQuantity in CSI-ReportConfig) is set/configured as “cri-RI-LI-PMI-CQI” (by RRC signaling).

For example, the report quantity of the CSI report being CRI, RI and i1 means that the report quantity parameter of the CSI report (reportQuantity, or reportQuantity in CSI-ReportConfig) is set/configured as “cri-RI-i1” (by RRC signaling).

For example, the report quantity of the CSI report being CRI, RI, i1 and CQI means that the report quantity parameter of the CSI report (reportQuantity, or reportQuantity in CSI-ReportConfig) is set/configured as “cri-RI-i1-CQI” (by RRC signaling).

For example, the report quantity of CSI being CRI, RI and CQI means that the report quantity parameter of the CSI report (reportQuantity, or reportQuantity in CSI-ReportConfig) is set/configured as “cri-RI-CQI” (by RRC signaling).

The UE determines the CSI parameter(s) according to the reference signal(s) (resource(s)) measured at the specific time.

For example, the specific time is the first time resource. For example, the first time resource corresponds to/is associated with the same first information. For example, the UE determines the CSI parameter(s) according to the reference signal measured at the first time resource (corresponding to/associated with the same first information).

For example, the reference signal resource is a (NZP) CSI-RS resource in the CSI-RS set for channel measurement and/or interference measurement associated with the report. For example, the reference signal resource is CSI-IM. For example, the reference signal(s) (resource(s)) is periodic or semi-persistent. For example, the reference signal(s) (resource(s)) is aperiodic.

For example, the description of the first time resource refers to Embodiment 5.

Embodiment 10 provides a method for determining CSI parameters, so that UE can determine CSI parameters according to the measurement at a specific time, and improve the accuracy of CSI feedback.

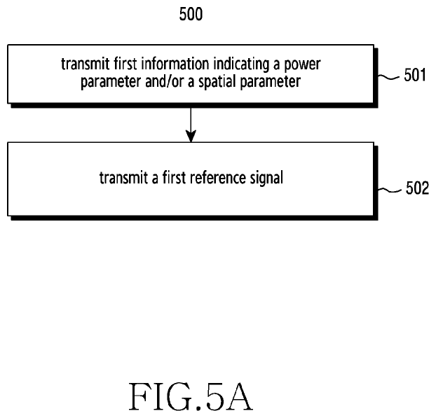

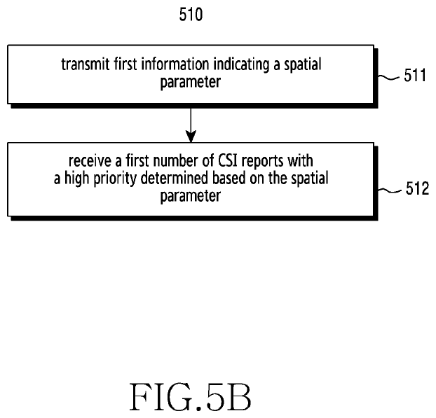

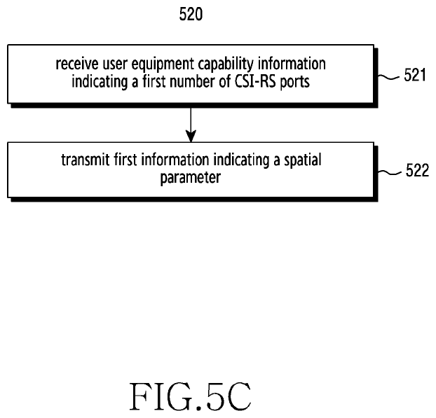

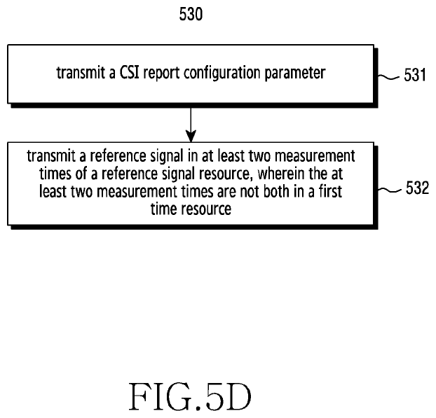

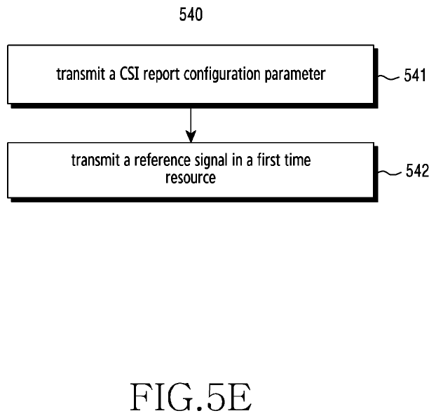

FIG. 5A illustrates a flowchart of a method 500 performed by a base station according to various embodiments of the present disclosure. The method 500 includes a step 501 and a step 502. At step 501, the base station transmits first information to a user equipment, wherein the first information indicates power parameters and/or spatial parameters. At step 502, the base station transmits a first reference signal to the user equipment. The first reference signal is associated with at least one of a set identifier indicated by the first information, a number of ports indicated by the first information, a transmission configuration indication (TCI) state, a physical cell identification (ID) or a serving cell, and at least one of periodicity, semi-persistence or aperiodicity.

FIG. 5B illustrates a flowchart of a method 510 performed by a base station according to various embodiments of the present disclosure. The method 510 includes a step 511 and a step 512. At step 511, the base station transmits first information to a user equipment, wherein the first information indicates a spatial parameter. At step 512, the base station receives a first number of CSI reports with a high priority determined based on the spatial parameter from the user equipment.

FIG. 5C illustrates a flowchart of a method 520 performed by a base station according to various embodiments of the present disclosure. The method 520 includes a step 521 and a step 522. At step 521, the base station receives user equipment capability information indicating a first number of CSI-RS ports from a user equipment. At step 522, the base station transmits first information indicating a spatial parameter to the user equipment, wherein a second number of CSI-RS ports determined according to the spatial parameter is less than or equal to the first number in a time unit.

FIG. 5D illustrates a flowchart of a method 530 performed by a base station according to various embodiments of the present disclosure. The method 530 includes a step 531 and a step 532. At step 531, the base station transmits a CSI report configuration parameter to a user equipment. At step 532, the base station transmits a reference signal in at least two measurement time instances of a reference signal resource. The at least two measurement time instances are not all in a first time resource, and the first time resource is included in at least one of a time resource determined according to the first information, a time domain resource determined according to a time domain position of a signal or channel related to the first information, a time resource used for a subband non-overlapped full duplex SBFD operation or not used for the SBFD operation, a cell discontinuous transmission inactive time or cell discontinuous transmission active time, or a UE discontinuous reception inactive time or UE discontinuous reception active time.

FIG. 5E illustrates a flowchart of a method 540 performed by a base station according to various embodiments of the present disclosure. The method 540 includes a step 541 and a step 542. At step 541, the base station transmits a CSI report configuration parameter to a user equipment. At step 542, the base station transmits a reference signal in a first time resource, wherein the first time resource is included in at least one of: a time resource determined according to the first information; a time domain resource determined according to a time domain position of a signal or channel related to the first information; a time resource used for a subband non-overlapped full duplex SBFD operation or not used for the SBFD operation; a cell discontinuous transmission inactive time or cell discontinuous transmission active time; and a UE discontinuous reception inactive time or UE discontinuous reception active time.

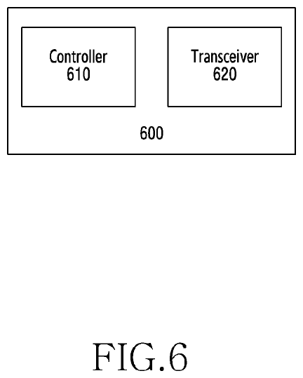

FIG. 6 illustrates a structure 600 of a UE according to various embodiments of the present disclosure. As shown in FIG. 6, the user equipment 600 includes a controller 610 and a transceiver 620, wherein the controller 610 is configured to perform various methods performed by the user equipment as disclosed herein above, and the transceiver 620 is configured to transmit/receive channels or signals. For example, the user equipment 600 corresponds to the UE of FIG. 1 to FIG. 5E.

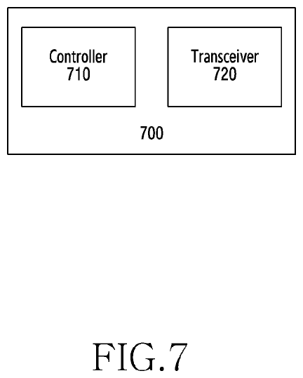

FIG. 7 illustrates a structure 700 of a base station according to various embodiments of the present disclosure. As shown in FIG. 7, the network device (e.g., base station) 700 includes a controller 710 and a transceiver 720, wherein the controller 710 is configured to perform various methods performed by the network device as disclosed herein above, and the transceiver 720 is configured to transmit/receive channels or signals. For example, the network device 700 (e.g., base station) corresponds to the base station of FIG. 1 to FIG. 5E.

An aspect of the present disclosure provides a method performed by a user equipment (UE) in a communication system, the method including: receiving first information; determining a channel state information CSI parameter associated with a first reference signal according to the first information in a case that the first reference signal satisfies a first condition; wherein the first condition includes at least one of: a set identifier associated with the first reference signal being associated with a set identifier indicated by the first information or a predefined set identifier; a number of ports associated with the first reference signal and a number of ports indicated by the first information or a predefined number of ports satisfying a second condition; a transmission configuration indication TCI state associated with the first reference signal being associated with a TCI state indicated by the first information or a predefined TCI state; a physical cell identifier PCI associated with the first reference signal being associated with a PCI of a serving cell of the UE; a serving cell associated with the first reference signal being associated with a serving cell indicated by the first information or a predefined serving cell; and the first reference signal being at least one of a periodic reference signal, a semi-persistent reference signal or an aperiodic reference signal.

In an example, the first information is associated with a first power parameter and/or a first spatial parameter.

In an example, in a case that the first reference signal satisfies the first condition and a configured report quantity of a CSI report satisfies a fourth condition, the channel state information CSI parameter associated with the first reference signal is determined according to the first information; wherein the fourth condition includes at least one of: the configured report quantity including: a CSI reference signal resource indicator CRI, a rank indicator RI, a precoding matrix indicator PMI, and a channel quality indicator CQI; the configured report quantity including: a CRI, an RI, a layer indicator LI, a PMI, and a CQI; the configured report quantity including: a CRI, an RI, and a codebook-related parameter; the configured report quantity including: a CRI, an RI, a codebook-related parameter, and a CQI; and the configured report quantity including: a CRI, an RI and a CQI.

In an example, the CSI parameter associated with the first reference signal is determined according to the first information in a case that the first information is carried in first signaling and the first signaling is further used to trigger or activate a first CSI report associated with the CSI parameter.

In an example, the CSI parameter is further associated with a configuration of a first CSI report, and in a case that the first CSI report is at least one of a periodic report, a semi-persistent report, or an aperiodic report, the CSI parameter associated with the first reference signal is determined according to the first information.

In an example, the method further includes: receiving first power configuration information, wherein the first power parameter includes: a power parameter indicated by the first information among power parameters related to the first power configuration information; or a power parameter determined based on the first information and a power parameter determined based on the first power configuration information.

In an example, the method further includes: receiving first spatial configuration information, wherein the first spatial parameter(s) includes: spatial parameter(s) indicated by the first information among spatial parameters related to the first spatial configuration information; or an intersection or union of spatial parameters determined based on the first information and spatial parameters determined based on the first spatial configuration information.

Another aspect of the present disclosure provides a method performed by a user equipment (UE) in a communication system, the method including: receiving first information associated with a first power parameter and/or a first spatial parameter; applying the first power parameter and/or the first spatial parameter in a first time resource, wherein the first time resource is included in at least one of: a time resource determined according to the first information; a time domain resource determined according to a time domain position of a signal or channel related to the first information; a time resource for subband non-overlapped full duplex SBFD or not for the SBFD; a cell discontinuous transmission inactive time or cell discontinuous transmission active time; and a UE discontinuous reception inactive time or UE discontinuous reception active time.

In an example, the first information is associated with a first power parameter and/or a first spatial parameter.

Another aspect of the present disclosure provides a method performed by a user equipment (UE) in a communication system, the method including: receiving first information associated with a first power parameter and/or a first spatial parameter; updating a first number of channel state information CSI reports with a high priority, wherein the first number is determined according to the first information.

In an example, the first information is associated with a first power parameter and/or a first spatial parameter.

In an example, when the CSI reports satisfy at least one of third conditions, the first number is determined according to the first spatial parameter, or the first number is a predefined number; wherein the third conditions include at least one of: a downlink control information DCI format triggering the CSI reports being after a signal or channel carrying the first information; a CSI reference resource of the CSI reports being after the signal or channel carrying the first information; the CSI reports being triggered aperiodically; the CSI reports not transmitting a physical uplink shared channel PUSCH with hybrid automatic repeat-acknowledgement HARQ-ACK and/or a transport block TB; CSI of the CSI reports corresponds to CSI in a single wideband frequency domain granularity; the CSI of the CSI reports corresponds to at most four CSI-RS ports in a single resource; the CSI of the CSI reports not having CSI reference signal resource indicator CRI reports; and a report quantity of the CSI reports is a CRI, a rank indicator RI, and a channel quality indicator CQI.

Another aspect of the present disclosure provides a method performed by a user equipment (UE) in a communication system, the method including: reporting UE capability information for indicating a first number of channel state information reference signal CSI-RS ports; receiving first information associated with a first power parameter and/or a first spatial parameter; wherein in one time unit, a second number is less than or equal to the first number, and the second number is a number of the CSI-RS ports determined according to the first information.

In an example, the first information is associated with a first power parameter and/or a first spatial parameter.

In an example, the one time unit is in a first time resource and the first time resource is included in at least one of: a time resource determined according to the first information; a time domain resource determined according to a time domain position of a signal or channel related to the first information; a time resource for subband non-overlapped full duplex SBFD or not for the SBFD; a cell discontinuous transmission inactive time or cell discontinuous transmission active time; and a UE discontinuous reception inactive time or UE discontinuous reception active time.

In an example, in a case that the second number is less than or equal to the first number and the CSI-RS ports are used for at least one of an aperiodic CSI-RS, a semi-persistent CSI-RS and an aperiodic CSI-RS, the second number is the number of the CSI-RS ports determined according to the first information.

Another aspect of the present disclosure provides a method performed by a user equipment (UE) in a communication system, the method including: receiving a channel state information CSI report configuration parameter; determining a CSI parameter according to the CSI report configuration parameter without averaging at least two measurement time instances of a reference signal resource associated with the CSI report, wherein the at least two measurement time instances are not all in a first time resource, and the first time resource is included in at least one of: a time resource determined according to the received first information; a time domain resource determined according to a time domain position of a signal or channel related to the received first information; a time resource for subband non-overlapped full duplex SBFD or not for the SBFD; a cell discontinuous transmission inactive time or cell discontinuous transmission active time; a UE discontinuous reception inactive time or UE discontinuous reception active time; wherein the first information is associated with a first power parameter and/or a first spatial parameter.

In an example, in a case that the at least two measurement time instances of the reference signal resource associated with the CSI report are not averaged and a configured report quantity of the CSI report satisfies a fourth condition, the CSI parameter is determined according to the CSI report configuration parameter, wherein the fourth condition includes at least one of: the configured report quantity including: a CSI reference signal resource indicator CRI, a rank indicator RI, a precoding matrix indicator PMI, and a channel quality indicator CQI; the configured report quantity including: a CRI, an RI, a layer indicator LI, a PMI, and a CQI; the configured report quantity including: a CRI, an RI, and a codebook-related parameter; the configured report quantity including: a CRI, an RI, a codebook-related parameter, and a CQI; and the configured report quantity including: a CRI, an RI, and a CQI.

Another aspect of the present disclosure provides a method performed by a user equipment (UE) in a communication system, the method including: receiving a channel state information CSI report configuration parameter; determining a CSI parameter according to the CSI report configuration parameter and a reference signal measured in a first time resource, wherein the first time resource is included in at least one of: a time resource determined according to the received first information; a time domain resource determined according to a time domain position of a signal or channel related to the received first information; a time resource for subband non-overlapped full duplex SBFD or not for the SBFD; a cell discontinuous transmission inactive time or cell discontinuous transmission active time; a UE discontinuous reception inactive time or UE discontinuous reception active time.

In an example, when a configured report quantity of the CSI report satisfies a fourth condition, the CSI parameter is determined according to the CSI report configuration parameter and the reference signal measured in the first time resource, wherein the fourth condition includes at least one of: the configured report quantity including: a CSI reference signal resource indicator CRI, a rank indicator RI, a precoding matrix indicator PMI, and a channel quality indicator CQI; the configured report quantity including: a CRI, an RI, a layer indicator LI, a PMI, and a CQI; the configured report quantity including: a CRI, an RI, and a codebook-related parameter; the configured report quantity including: a CRI, an RI, a codebook-related parameter, and a CQI; and the configured report quantity including: a CRI, an RI and a CQI.

Another aspect of the present disclosure provides a method performed by a base station in a communication system, the method including: transmitting first information; transmitting a first reference signal, wherein the first reference signal satisfies a first condition, and the first condition includes at least one of: a set identifier associated with the first reference signal being associated with a set identifier indicated by the first information or a predefined set identifier; a number of ports associated with the first reference signal and a number of ports indicated by the first information or a predefined number of ports satisfying a second condition; a transmission configuration indication TCI state associated with the first reference signal being associated with a TCI state indicated by the first information or a predefined TCI state; a physical cell identifier PCI associated with the first reference signal being associated with a PCI of a serving cell of the UE; a serving cell associated with the first reference signal being associated with a serving cell indicated by the first information or a predefined serving cell; and the first reference signal being at least one of a periodic reference signal, a semi-persistent reference signal or an aperiodic reference signal.

In an example, the first information is associated with a first power parameter and/or a first spatial parameter.

Another aspect of the present disclosure provides a method performed by a base station in a communication system, the method including: transmitting first information; receiving a first number of channel state information CSI reports with a high priority, wherein the first number is determined according to the first information.

In an example, the first information is associated with a first power parameter and/or a first spatial parameter.

Another aspect of the present disclosure provides a method performed by a base station in a communication system, the method including: receiving UE capability information for indicating a first number of channel state information reference signal CSI-RS ports; transmitting first information associated with a first power parameter and/or a first spatial parameter; transmitting a CSI-RS; wherein in one time unit, a second number is less than or equal to the first number, and the second number is a number of the CSI-RS ports determined according to the first information.

In an example, the first information is associated with a first power parameter and/or a first spatial parameter.

Another aspect of the present disclosure provides a method performed by a base station in a communication system, the method including: transmitting a channel state information CSI report configuration parameter; transmitting a reference signal in at least two measurement time instances of a reference signal resource, wherein the at least two measurement time instances are not all in a first time resource, and the first time resource is included in at least one of: a time resource determined according to the received first information; a time domain resource determined according to a time domain position of a signal or channel related to the received first information; a time resource for subband non-overlapped full duplex SBFD or not for the SBFD; a cell discontinuous transmission inactive time or cell discontinuous transmission active time; and a UE discontinuous reception inactive time or UE discontinuous reception active time.

Another aspect of the present disclosure provides a method performed by a base station in a communication system, the method including: transmitting a channel state information CSI report configuration parameter; transmitting a reference signal in a first time resource, wherein the first time resource is included in at least one of: a time resource determined according to the received first information; a time domain resource determined according to a time domain position of a signal or channel related to the received first information; a time resource for subband non-overlapped full duplex SBFD or not for the SBFD; a cell discontinuous transmission inactive time or cell discontinuous transmission active time; and a UE discontinuous reception inactive time or UE discontinuous reception active time.

Another aspect of the present disclosure provides a user equipment in a communication system, including a transceiver and a processor coupled to the transceiver, wherein the processor is configured to perform a method that can be performed by the user equipment according to an embodiment of the present disclosure.

Another aspect of the present disclosure provides a base station in a communication system, including a transceiver and a processor coupled to the transceiver, wherein the processor is configured to perform a method that can be performed by the base station according to an embodiment of the present disclosure.

A method performed by a user equipment (UE) in a wireless communication system is provided. The method comprises receiving, from a base station, configuration information on a channel state information (CSI) report, wherein the configuration information includes information on one or more sub-configurations for the CSI report, receiving, from the base station, a medium access control (MAC) control element (CE) for activating at least one sub-configuration among the one or more sub-configurations and transmitting, to the base station, the CSI report for the at least one sub-configuration based on the MAC CE.

Each of the one or more sub-configurations includes at least one of information associated with one or more antenna ports, information on a codebook subset restriction, or information on a power offset, and each of the one or more sub-configurations is associated with a non-zero-power (NZP) CSI reference signal (RS) resource.

Antenna ports for each of the one or more sub-configurations are mapped to consecutive antenna ports starting at antenna ports 3000 in increasing order of an index of the antenna ports, and the UE is not configured with more active antenna ports in active bandwidth parts (BWPs) than an antenna port capability of the UE.

A number of active antenna ports for a CSI reference signal (RS) is identified based on a maximum value between a number of antenna ports configured for CSI RS resources and a number of antenna ports which are derived from information on one or more antenna ports.

A number of a CSI processing unit (CPU) for a semi-persistent CSI report is identified based on a number of CSI reference signal (RS) resources corresponding to the at least one sub-configuration.

A user equipment (UE) in a wireless communication system is provided. The UE comprises a transceiver and a controller coupled with the transceiver and configured to receive, from a base station, configuration information on a channel state information (CSI) report, wherein the configuration information includes information on one or more sub-configurations for the CSI report, receive, from the base station, a medium access control (MAC) control element (CE) for activating at least one sub-configuration among the one or more sub-configurations, and transmit, to the base station, the CSI report for the at least one sub-configuration based on the MAC CE.

Each of the one or more sub-configurations includes at least one of information associated with one or more antenna ports, information on a codebook subset restriction, or information on a power offset, and each of the one or more sub-configurations is associated with a non-zero-power (NZP) CSI reference signal (RS) resource.

Antenna ports for each of the one or more sub-configurations are mapped to consecutive antenna ports starting at antenna ports 3000 in increasing order of an index of the antenna ports, and the UE is not configured with more active antenna ports in active bandwidth parts (BWPs) than an antenna port capability of the UE.

A number of active antenna ports for a CSI reference signal (RS) is identified based on a maximum value between a number of antenna ports configured for CSI RS resources and a number of antenna ports which are derived from information on one or more antenna ports.

A number of a CSI processing unit (CPU) for a semi-persistent CSI report is identified based on a number of CSI reference signal (RS) resources corresponding to the at least one sub-configuration.

A method performed by a base station in a wireless communication system is provided. The method comprises transmitting, to a user equipment (UE), configuration information on a channel state information (CSI) report, wherein the configuration information includes information on one or more sub-configurations for the CSI report, transmitting, to the UE, a medium access control (MAC) control element (CE) for activating at least one sub-configuration among the one or more sub-configurations and receiving, from the UE, the CSI report for the at least one sub-configuration based on the MAC CE.

Each of the one or more sub-configurations includes at least one of information associated with one or more antenna ports, information on a codebook subset restriction, or information on a power offset, and each of the one or more sub-configurations is associated with a non-zero-power (NZP) CSI reference signal (RS) resource.

Antenna ports for each of the one or more sub-configurations are mapped to consecutive antenna ports starting at antenna ports 3000 in increasing order of an index of the antenna ports.

A number of active antenna ports for a CSI reference signal (RS) is based on a maximum value between a number of antenna ports configured for CSI RS resources and a number of antenna ports which are based on information on one or more antenna ports.

A number of a CSI processing unit (CPU) for a semi-persistent CSI report is based on a number of CSI reference signal (RS) resources corresponding to the at least one sub-configuration.

A base station in a wireless communication system is provided. The base station comprises a transceiver and a controller coupled with the transceiver and configured to transmit, to a user equipment (UE), configuration information on a channel state information (CSI) report, wherein the configuration information includes information on one or more sub-configurations for the CSI report, transmit, to the UE, a medium access control (MAC) control element (CE) for activating at least one sub-configuration among the one or more sub-configurations, and receive, from the UE, the CSI report for the at least one sub-configuration based on the MAC CE.

Each of the one or more sub-configurations includes at least one of information associated with one or more antenna ports, information on a codebook subset restriction, or information on a power offset, and each of the one or more sub-configurations is associated with a non-zero-power (NZP) CSI reference signal (RS) resource.

Antenna ports for each of the one or more sub-configurations are mapped to consecutive antenna ports starting at antenna ports 3000 in increasing order of an index of the antenna ports.

A number of active antenna ports for a CSI reference signal (RS) is based on a maximum value between a number of antenna ports configured for CSI RS resources and a number of antenna ports which are based on information on one or more antenna ports.

A number of a CSI processing unit (CPU) for a semi-persistent CSI report is based on a number of CSI reference signal (RS) resources corresponding to the at least one sub-configuration.

In various embodiments of the present disclosure, the description of “reference signal” may be replaced by the description of “reference signal resource”.

In various embodiments of the present disclosure, the description of “the largest” in “the (largest) number of consecutive port IDs corresponding to/associated with port ID information” should be understood as that there may be more than one consecutive ID in a set of ports, so the largest number of consecutive IDs is selected, but there may also be several consecutive IDs that are the same, so it is not necessary to explicitly state that they are the largest.

In addition, “at least one item/at least one” described in the present disclosure includes any and/or all possible combinations of listed items, and various embodiments and various examples in embodiments described in the present disclosure can be changed and combined in any suitable form, and “/” described in the present disclosure represents “and/or”.

The illustrative logical blocks, modules, and circuits described in the present disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in the present disclosure may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the present disclosure is illustrative of an exemplary process. Based on the design preference, it can be understood that the specific order or hierarchy of steps in the method can be rearranged to realize the functions and effects disclosed in the present disclosure. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the present disclosure is not limited to the illustrated examples, and any means for performing the functions described herein are included in various aspects of the present disclosure.

Text and drawings are provided as examples only to help readers understand the present disclosure. They are not intended and should not be construed to limit the scope of the present disclosure in any way. Although certain embodiments and examples have been provided, based on the disclosure herein, it is obvious to those skilled in the art that changes can be made to the illustrated embodiments and examples without departing from the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, configuration information on a channel state information (CSI) report, wherein the configuration information includes information on one or more sub-configurations for the CSI report;
receiving, from the base station, a medium access control (MAC) control element (CE) for activating at least one sub-configuration among the one or more sub-configurations; and
transmitting, to the base station, the CSI report for the at least one sub-configuration based on the MAC CE.

2. The method of claim 1, wherein each of the one or more sub-configurations includes at least one of information associated with one or more antenna ports, information on a codebook subset restriction, or information on a power offset, and
wherein each of the one or more sub-configurations is associated with a non-zero-power (NZP) CSI reference signal (RS) resource.

3. The method of claim 1, wherein antenna ports for each of the one or more sub-configurations are mapped to consecutive antenna ports starting at antenna ports 3000 in increasing order of an index of the antenna ports, and
wherein the UE is not configured with more active antenna ports in active bandwidth parts (BWPs) than an antenna port capability of the UE.

4. The method of claim 1, wherein a number of active antenna ports for a CSI reference signal (RS) is identified based on a maximum value between a number of antenna ports configured for CSI RS resources and a number of antenna ports which are derived from information on one or more antenna ports.

5. The method of claim 1, wherein a number of a CSI processing unit (CPU) for a semi-persistent CSI report is identified based on a number of CSI reference signal (RS) resources corresponding to the at least one sub-configuration.

6. A user equipment (UE) in a wireless communication system, the UE comprising:
a transceiver; and
a controller coupled with the transceiver and configured to:
receive, from a base station, configuration information on a channel state information (CSI) report, wherein the configuration information includes information on one or more sub-configurations for the CSI report,
receive, from the base station, a medium access control (MAC) control element (CE) for activating at least one sub-configuration among the one or more sub-configurations, and
transmit, to the base station, the CSI report for the at least one sub-configuration based on the MAC CE.

7. The UE of claim 6, wherein each of the one or more sub-configurations includes at least one of information associated with one or more antenna ports, information on a codebook subset restriction, or information on a power offset, and
wherein each of the one or more sub-configurations is associated with a non-zero-power (NZP) CSI reference signal (RS) resource.

8. The UE of claim 6, wherein antenna ports for each of the one or more sub-configurations are mapped to consecutive antenna ports starting at antenna ports 3000 in increasing order of an index of the antenna ports, and
wherein the UE is not configured with more active antenna ports in active bandwidth parts (BWPs) than an antenna port capability of the UE.

9. The UE of claim 6, wherein a number of active antenna ports for a CSI reference signal (RS) is identified based on a maximum value between a number of antenna ports configured for CSI RS resources and a number of antenna ports which are derived from information on one or more antenna ports.

10. The UE of claim 6, wherein a number of a CSI processing unit (CPU) for a semi-persistent CSI report is identified based on a number of CSI reference signal (RS) resources corresponding to the at least one sub-configuration.

11. A method performed by a base station in a wireless communication system, the method comprising:
transmitting, to a user equipment (UE), configuration information on a channel state information (CSI) report, wherein the configuration information includes information on one or more sub-configurations for the CSI report;
transmitting, to the UE, a medium access control (MAC) control element (CE) for activating at least one sub-configuration among the one or more sub-configurations; and
receiving, from the UE, the CSI report for the at least one sub-configuration based on the MAC CE.

12. The method of claim 11, wherein each of the one or more sub-configurations includes at least one of information associated with one or more antenna ports, information on a codebook subset restriction, or information on a power offset, and
wherein each of the one or more sub-configurations is associated with a non-zero-power (NZP) CSI reference signal (RS) resource.

13. The method of claim 11, wherein antenna ports for each of the one or more sub-configurations are mapped to consecutive antenna ports starting at antenna ports 3000 in increasing order of an index of the antenna ports.

14. The method of claim 11, wherein a number of active antenna ports for a CSI reference signal (RS) is based on a maximum value between a number of antenna ports configured for CSI RS resources and a number of antenna ports which are based on information on one or more antenna ports.

15. The method of claim 11, wherein a number of a CSI processing unit (CPU) for a semi-persistent CSI report is based on a number of CSI reference signal (RS) resources corresponding to the at least one sub-configuration.

16. A base station in a wireless communication system, the base station comprising:
a transceiver; and
a controller coupled with the transceiver and configured to:
transmit, to a user equipment (UE), configuration information on a channel state information (CSI) report, wherein the configuration information includes information on one or more sub-configurations for the CSI report,
transmit, to the UE, a medium access control (MAC) control element (CE) for activating at least one sub-configuration among the one or more sub-configurations, and
receive, from the UE, the CSI report for the at least one sub-configuration based on the MAC CE.

17. The base station of claim 16, wherein each of the one or more sub-configurations includes at least one of information associated with one or more antenna ports, information on a codebook subset restriction, or information on a power offset, and
wherein each of the one or more sub-configurations is associated with a non-zero-power (NZP) CSI reference signal (RS) resource.

18. The base station of claim 16, wherein antenna ports for each of the one or more sub-configurations are mapped to consecutive antenna ports starting at antenna ports 3000 in increasing order of an index of the antenna ports.

19. The base station of claim 16, wherein a number of active antenna ports for a CSI reference signal (RS) is based on a maximum value between a number of antenna ports configured for CSI RS resources and a number of antenna ports which are based on information on one or more antenna ports.

20. The base station of claim 16, wherein a number of a CSI processing unit (CPU) for a semi-persistent CSI report is based on a number of CSI reference signal (RS) resources corresponding to the at least one sub-configuration.
